(19) United States
(12) Patent Application Publication
(10) Pub. No.: US 2026/0292259 A1
(43) Pub. Date: Sep. 24, 2026

(54) DECODING METHOD, CODING METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Han ZHANG, Shenzhen (CN); Minhao TANG, Shenzhen (CN)

(73) Assignee: TENCENT TECHNOLOGY (SHENZHEN) COMPANY LIMITED, Shenzhen (CN)

(21) Appl. No.: 19/687,906

(22) Filed: May 26, 2026

Related U.S. Application Data
(63) Continuation of application No. PCT/CN2024/139704, filed on Dec. 16, 2024.

(30) Foreign Application Priority Data
Jan. 8, 2024 (CN) 202410031983.9

(51) Int. Cl. H04N 19/70; H04N 19/117; H04N 19/82

(52) U.S. Cl. CPC H04N 19/70; H04N 19/117; H04N 19/82

(57) ABSTRACT

A method for decoding performed by an electronic device. The method includes parsing a bitstream, to determine a target flag in the bitstream indicating whether tap coefficients of at least one filter use a shared nonlinear clipping index; and obtaining, based on a value of the target flag being a first value, a target nonlinear clipping index from the bitstream, the target nonlinear clipping index being shared by the tap coefficients of the at least one filter.

### CROSS-REFERENCE TO RELATED APPLICATION(S)

This application is a bypass continuation application of International Patent Application No. PCT/CN2024/139704, filed on Dec. 16, 2024, which claims priority to and is based on Chinese Patent Application No. 202410031983.9, filed on Jan. 8, 2024, the disclosures of which are incorporated herein in their entireties by reference.

### FIELD

Some embodiments of the present disclosure relate to the field of video coding/decoding technologies, and in particular, to a decoding method, a coding method, an electronic device, and a computer-readable storage medium.

### BACKGROUND

As a loop filter adopted in versatile video coding (VVC), adaptive loop filtering (ALF) and cross-component adaptive loop filtering (CCALF) belong to Wiener filters. A Wiener filter is a linear filter, and only a spatial similarity between adjacent pixels and a current to-be-processed pixel is considered in a filtering process. To enable the Wiener filter to simultaneously consider the spatial similarity and a sample similarity between the adjacent pixels and the current to-be-processed pixel, a nonlinear clipping operation may be used. To be specific, a difference between an input of the Wiener filter and the current pixel is limited by means of clipping.

In the related art, the nonlinear clipping operation is used, and a nonlinear filter index needs to be transmitted for each tap coefficient of a filter. However, as a quantity of filter tap coefficients and a quantity of supportable filter banks are increased, bit overheads required for transmitting the nonlinear clipping index are significantly increased, affecting video compression efficiency.

Information disclosed in this Background section was either known to the inventors before achieving the present disclosure or represents technical information acquired during the development process. Therefore, it may contain information that does not constitute prior art known to the public.

### SUMMARY

Some embodiments of the present disclosure provide a decoding method, a coding method, an electronic device, and a computer-readable storage medium, to facilitate improving video compression efficiency.

According to some embodiments of the present disclosure, a method for decoding performed by an electronic device includes parsing a bitstream, to determine a target flag in the bitstream indicating whether tap coefficients of at least one filter use a shared nonlinear clipping index; and obtaining, based on a value of the target flag being a first value, a target nonlinear clipping index from the bitstream, the target nonlinear clipping index being shared by the tap coefficients of the at least one filter.

According to some embodiments of the present disclosure, an electronic device for decoding includes at least one memory configured to store computer program code; and at least one processor configured to read the program code and operate as instructed by the program code. The program code is configured to cause the at least one processor to, parse a bitstream, to determine a target flag in the bitstream indicating whether tap coefficients of at least one filter use a shared nonlinear clipping index; and obtain, based on a value of the target flag being a first value, a target nonlinear clipping index from the bitstream, the target nonlinear clipping index being shared by the tap coefficients of the at least one filter.

According to some embodiments of the present disclosure, a non-transitory computer-readable storage medium, storing computer program code, when executed by at least one processor, causes the at least one processor to at least, parse a bitstream, to determine a target flag in the bitstream indicating whether tap coefficients of at least one filter use a shared nonlinear clipping index; and obtain, based on a value of the target flag being a first value, a target nonlinear clipping index from the bitstream, the target nonlinear clipping index being shared by the tap coefficients of the at least one filter.

According to some embodiments of the present disclosure, a method for coding performed by an electronic device includes determining a value of a target flag indicating whether tap coefficients of at least one filter use a shared nonlinear clipping index; writing the target flag into a bitstream; and writing, based on the value of the target flag being a first value, a target nonlinear clipping index into the bitstream, the target nonlinear clipping index being shared by the tap coefficients of the at least one filter.

According to some embodiments of the present disclosure, an electronic device for coding includes at least one memory configured to store computer program code; and at least one processor configured to read the program code and operate as instructed by the program code. The program code is configured to cause the at least one processor to, determine a value of a target flag indicating whether tap coefficients of at least one filter use a shared nonlinear clipping index; write the target flag into a bitstream; and write, based on the value of the target flag being a first value, a target nonlinear clipping index into the bitstream, the target nonlinear clipping index being shared by the tap coefficients of the at least one filter.

According to some embodiments of the present disclosure, a non-transitory computer-readable storage medium, storing computer program code, when executed by at least one processor, causes the at least one processor to at least, determine a value of a target flag indicating whether tap coefficients of at least one filter use a shared nonlinear clipping index; write the target flag into a bitstream; and write, based on the value of the target flag being a first value, a target nonlinear clipping index into the bitstream, the target nonlinear clipping index being shared by the tap coefficients of the at least one filter.

Some embodiments of the present disclosure may provide improvements in computer technology or in any other technical field. For example, an electronic device may determine a target flag and a value thereof by parsing a bitstream. If the value of the target flag is a first value, it indicates that there is a filter having tap coefficients using a shared nonlinear clipping index. If the value of the target flag is not the first value, it indicates that there is no filter having tap coefficients using the shared nonlinear clipping index. Further, in a case that the value of the target flag is the first value, the electronic device further obtains a target nonlinear clipping index from the bitstream. The target nonlinear clipping index is the nonlinear clipping index shared by the tap coefficients of the filter. In some embodiments of the present disclosure, nonlinear clipping indexes respectively corresponding to a plurality of tap coefficients of the filter may be represented by one target nonlinear clipping index. For the same quantity of tap coefficients, the solution provided in some embodiments of the present disclosure can reduce a quantity of nonlinear clipping indexes. Therefore, some embodiments can effectively reduce bit overheads of the nonlinear clipping indexes, thereby facilitating improving video compression efficiency.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is a schematic diagram of ALF and CCALF processing procedures according to some embodiments of the present disclosure;

FIG. 2 is a schematic diagram of a shape of an ALF device according to some embodiments of the present disclosure;

FIG. 3 is a schematic diagram of a shape of an ECM-8.0 ALF filter according to some embodiments of the present disclosure;

FIG. 4 is a schematic flowchart of a decoding method according to some embodiments of the present disclosure;

FIG. 5 is a schematic flowchart of a decoding method according to some embodiments of the present disclosure;

FIG. 6 is a schematic flowchart of a decoding method according to some embodiments of the present disclosure;

FIG. 7 is a schematic flowchart of a decoding method according to some embodiments of the present disclosure;

FIG. 8 is a schematic flowchart of a decoding method according to some embodiments of the present disclosure;

FIG. 9 is a schematic flowchart of a decoding method according to some embodiments of the present disclosure;

FIG. 10 is a schematic flowchart of a decoding method according to some embodiments of the present disclosure;

FIG. 11 is a schematic flowchart of a decoding method according to some embodiments of the present disclosure;

FIG. 12 is a schematic flowchart of a decoding method according to some embodiments of the present disclosure;

FIG. 13 is a schematic flowchart of a decoding method according to some embodiments of the present disclosure;

FIG. 14 is a schematic flowchart of a decoding method according to some embodiments of the present disclosure;

FIG. 15 is a schematic flowchart of a decoding method according to some embodiments of the present disclosure;

FIG. 16 is a schematic flowchart of a decoding method according to some embodiments of the present disclosure;

FIG. 17 is a schematic flowchart of a decoding method according to some embodiments of the present disclosure;

FIG. 18 is a schematic flowchart of a decoding method according to some embodiments of the present disclosure;

FIG. 19 is a schematic flowchart of a decoding method according to some embodiments of the present disclosure;

FIG. 20 is a schematic flowchart of a coding method according to some embodiments of the present disclosure;

FIG. 21 is a schematic flowchart of a coding method according to some embodiments of the present disclosure;

FIG. 22 is a schematic flowchart of a coding method according to some embodiments of the present disclosure;

FIG. 23 is a schematic flowchart of a coding method according to some embodiments of the present disclosure;

FIG. 24 is a schematic flowchart of a coding method according to some embodiments of the present disclosure;

FIG. 25 is a schematic flowchart of a coding method according to some embodiments of the present disclosure;

FIG. 26 is a schematic flowchart of a coding method according to some embodiments of the present disclosure;

FIG. 27 is a schematic flowchart of a coding method according to some embodiments of the present disclosure;

FIG. 28 is a schematic flowchart of a coding method according to some embodiments of the present disclosure;

FIG. 29 is a schematic flowchart of a coding method according to some embodiments of the present disclosure;

FIG. 30 is a schematic flowchart of a coding method according to some embodiments of the present disclosure;

FIG. 31 is a schematic flowchart of a coding method according to some embodiments of the present disclosure;

FIG. 32 is a schematic flowchart of a coding method according to some embodiments of the present disclosure;

FIG. 33 is a schematic flowchart of a coding method according to some embodiments of the present disclosure;

FIG. 34 is a schematic flowchart of a coding method according to some embodiments of the present disclosure;

FIG. 35 is a schematic flowchart of a coding method according to some embodiments of the present disclosure;

FIG. 36 is a schematic structural diagram of a decoding apparatus according to some embodiments of the present disclosure;

FIG. 37 is a schematic structural diagram of a coding apparatus according to some embodiments of the present disclosure; and

FIG. 38 is a schematic structural diagram of an electronic device according to some embodiments of the present disclosure.

### DETAILED DESCRIPTION

Technical solutions in some embodiments of the present disclosure are clearly and completely described in the following with reference to the accompanying drawings in some embodiments of the present disclosure. Apparently, the described embodiments are merely some rather than all of some embodiments of the present disclosure. Based on some embodiments in the present disclosure, all other embodiments obtained by a person of ordinary skill in the art without making creative labor fall within the scope of protection of the present disclosure.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c. Also, expressions such as ‘a, b, or c’ may be understood as ‘at least one of a, b, or c’ unless explicitly stated otherwise, or unless the elements would only be understood as alternatives by a person ordinarily skilled in the art.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

With regard to the description of the drawings, similar reference numerals may be used to refer to similar or related components.

The operations, techniques, and processes described herein may be implemented via executable instructions or computer program code stored on computer-readable medium. Such computer program code may include distinct portions or modules, where each portion comprises a subset of the total instructions necessary to perform specific operations.

The term, involved in the following description, “some embodiments” describes subsets of all possible embodiments, but “some embodiments” may be the same subset or different subsets of all the possible embodiments and may be combined with each other without conflict. The embodiments with numbers are exemplary.

The numbered embodiments (e.g., “Embodiment 1”) are exemplary and should not be construed as limiting the description of any particular numbered embodiment solely to that embodiment. Various features recited in connection with a particular numbered embodiment may form part of other embodiments of the present disclosure. Additionally, the numbered embodiments may encompass more than one embodiment.

Data used in such a way is interchangeable in a proper case, so that some embodiments of the present disclosure described herein can be implemented, for example, in a sequence other than the sequence illustrated or described herein. In some embodiments of the present disclosure, “B corresponding to A” indicates that B is associated with A. In the descriptions of the present disclosure, unless otherwise specified, “plurality of” means two or more than two.

Unless explicitly described or implicitly understood from the embodiments of the present disclosure, at least one of the components, elements, modules, units, or nominalized verbs represented by a block or equivalent indication in the drawings may be implemented or embodied by software (e.g., a program) including one or more instructions stored in an internal or external storage medium that is readable by one or more processors. For example, the one or more processors may invoke at least one of the one or more instructions stored in the storage medium and execute it, with or without using one or more other components under the control of the one or more processors. This allows the one or more processors to perform at least one function or operation described above as being performed by each of the components according to the one or more instructions invoked. The one or more processors may include a central processing unit (CPU) to perform at least a portion of the one or more instructions and hardware accelerators such as a graphics processing unit (GPU), neural processing unit (NPU), tensor processing unit (TPU), vision processing unit (VPU), digital signal processor (DSP), special-purpose system on chip (SoC) (e.g., edge SoC), application-specific integrated circuit (ASIC), field-programmable gate array (FPGA), in-memory computing (IMC), quantum accelerator, or microcontroller. One or more nodes of a distributed computing system may perform the one or more instructions.

### 1. ALF and CCALF in VVC

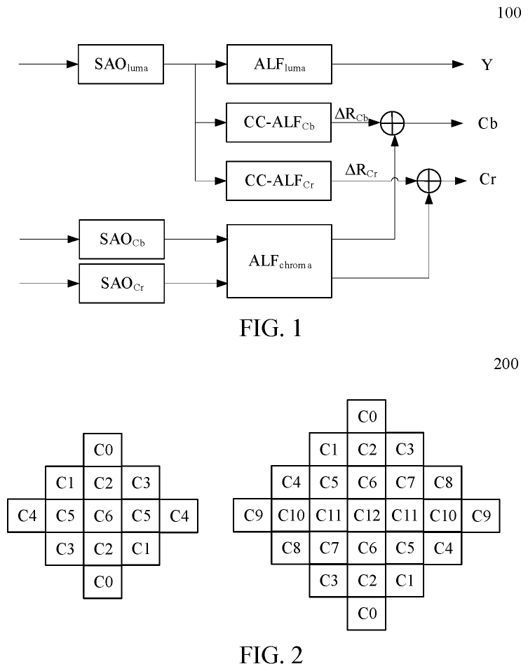

As loop filters adopted in the VVC, ALF and CCALF adaptively determine filter coefficients according to different video content, thereby reducing a mean square error (MSE) between a reconstructed component and an original component. FIG. 1 is a schematic diagram of ALF and CCALF processing procedures applicable to the present disclosure. An input of ALF is a reconstructed pixel value before ALF processing, with reference to a luma sample adaptive offset (SAO) SAOₗᵤₘₐ and chroma (CbCr) SAOs SAO_{Cr} and SAO_{Cb} as shown in FIG. 1. An output of ALF is an enhanced reconstructed luma picture and reconstructed chroma picture. As an adaptive filter, a Wiener filter may generate different filter coefficients for video content with different characteristics. Therefore, ALF needs to first classify video content, and then use a corresponding filter for video content of each category. In the design of VVC, each 4×4 block is classified into one of 25 categories according to directionality and activity thereof. A corresponding filter coefficient is calculated for each type of video content.

### 1.1. Shape of ALF Filter:

For a luma component, in addition to 4×4 block-level adaptation, VVC also supports a coding tree unit (CTU)-level ALF adaptive switch. Each CTU may use a filter bank generated by using a current slice, or may use a filter bank generated by using a coded slice, or a set of fixed filters in 16 fixed filter banks trained off line. In a CTU, each 4×4 block selects, according to a category to which the block belongs, a filter of a corresponding category from a filter bank for filtering. The filter coefficient and a corresponding clipping index are transmitted to a decoder side by using an ALF_adaptation parameter set (APS). One ALF_APS may include one luma filter bank (including a maximum of 25 filters) and a maximum of 8 chroma filters.

CALF uses a luma component to correct a chroma component. Referring to FIG. 1, CCALF uses a luma component SAOₗᵤₘₐ as an input, and correction values ΔR_{Cb} and ΔR_{Cr} of chroma components as outputs. Whether the corresponding correction values are used may be separately controlled for the two chroma components. The correction value and an output of the chroma ALF jointly form final chroma components Cb (representing blue chroma) and Cr (representing red chroma).

### Shape of ALF Filter:

In VVC, ALF uses rhombus filters of two different shapes shown in FIG. 2. A 7×7 rhombus filter is used for the luma component, and a 5×5 rhombus filter is used for the chroma component.

### Pixel Block Classification and Geometrical Transformation:

For the luma component, ALF adaptively uses different filters at a sub-block level (4×4). To be specific, each 4×4 pixel block needs to be classified into one of 25 categories. For the chroma component, ALF does not need to classify sub-block-level pixels, and all chroma pixels in a CTU use the same filter. A classification index C of a luma component pixel block is jointly derived from a directionality feature D and a quantized activity feature Â of the block according to equation (1):

$$C = 5 D + \hat{A} \qquad ( 1 )$$

To calculate the directionality feature D and the activity feature Â, it is first necessary to calculate horizontal, vertical, diagonal, and anti-diagonal gradient values of each pixel within a 4×4 pixel block, with reference to equations (2) to (5):

$${H}_{k , l} = \vert 2 R ( k , l ) - R ( k - 1 , l ) - R ( k + 1 , l ) \vert \qquad ( 2 )$$

$${V}_{k , l} = \vert 2 R ( k , l ) - R ( k , l - 1 ) - R ( k , l + 1 ) \vert \qquad ( 3 )$$

$$D {0}_{k , l} = \vert 2 R ( k , l ) - R ( k - 1 , l - 1 ) - R ( k + 1 , l + 1 ) \vert \qquad ( 4 )$$

$$D {1}_{k , l} = \vert 2 R ( k , l ) - R ( k - 1 , l + 1 ) - R ( k + 1 , l - 1 ) \vert \qquad ( 5 )$$

Based on pixel gradients, the following equations are calculated for overall horizontal, vertical, diagonal, and anti-diagonal gradients of each 4×4 block:

$${g}_{h} = {\sum }_{k = i - 2}^{i + 5} {\sum }_{l = j - 2}^{j + 5} {H}_{k , l} , {g}_{v} = {\sum }_{k = i - 2}^{i + 5} {\sum }_{l = j - 2}^{j + 5} {V}_{k , l} \qquad ( 6 )$$

$${g}_{d 0} = {\sum }_{k = i - 2}^{i + 5} {\sum }_{l = j - 2}^{j + 5} D {0}_{k , l} , {g}_{d 1} = {\sum }_{k = i - 2}^{i + 5} {\sum }_{l = j - 2}^{j + 5} D {1}_{k , l} \qquad ( 7 )$$

where i and j represent coordinates of an upper-left pixel of a 4×4 pixel block, and R(k, l) represents a reconstructed pixel value of a (k, l) position before ALF is performed.

After obtaining the gradient values of the pixel block, maximum and minimum values of the horizontal and vertical gradient values are given by equation (8) and equation (9), respectively:

$${g}_{h , v}^{max} = max ( {g}_{h} , {g}_{v} ) , {g}_{h , v}^{min} = min ( {g}_{h} , {g}_{v} ) \qquad ( 8 )$$

Maximum and minimum values of the diagonal and anti-diagonal gradient values are respectively:

$${g}_{d 0 , d 1}^{max} = max ( {g}_{d 0} , {g}_{d 1} ) , {g}_{d0 , d 1}^{min} = min ( {g}_{d 0} , {g}_{d 1} ) \qquad ( 9 )$$

The directionality feature D is derived by comparing the maximum and minimum values of the gradient values in the four directions obtained by using the equations (8) to (9):
Operation 1: Set D as 0 if

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are satisfied simultaneously.
Operation 2: Proceed to operation 3 if

$${g}_{h , v}^{max} / {g}_{h , v}^{min} > {g}_{d 0 , d 1}^{max} / {g}_{d 0 , d 1}^{min}$$

is satisfied, otherwise, proceed to operation 4.
Operation 3: Set D as 2 if

$${g}_{h ,}^{max} > {t}_{2} \cdot {g}_{{h}_{p} v}^{min}$$

is satisfied, otherwise, set D as 1.
Operation 4: Set D as 4 if

$${g}_{d 0 , d 1}^{max} > {t}_{2} \cdot {g}_{d 0 , d 1}^{min}$$

is satisfied, otherwise, set D as 3.

The activity feature A is calculated by using the following equation:

$$A = {\sum }_{k = i - 2}^{i + 5} {\sum }_{l = j - 2}^{j + 5} ( {V}_{k , l} + {H}_{k , l} ) \qquad ( 10 )$$

The activity feature A is quantized to an interval of [0-4] and serves as a quantized activity feature Â.

Prior to filtering each 4×4 luma block, geometrical transformation is performed on filter coefficients and corresponding clipping values according to a gradient value of a current block, following geometrical transformation rules based on pixel block gradient values as shown in Table 1. Such transformations include no transformation, diagonal, vertical flip, and rotation. Applying geometrical transformation to the filter coefficients is equivalent to applying geometrical transformation to pixel values and then performing filtering while keeping the coefficients unchanged. The geometrical transformation is performed to align the directionality of content in different blocks as much as possible, thereby reducing the number of classifications for ALF and enabling different pixels to share the same filter coefficients. Using geometrical transformation increases an actual number of classifications from 25 to 100 without increasing the number of ALF filters, thus improving adaptability.

TABLE 1

| Gradient value | Several transformations |
|---|---|
| g_{d1} < g_{d0} and gₕ < gᵥ | Unchanged |
| g_{d1} < g_{d0} and gᵥ ≤ gₕ | Diagonal |
| g_{d0} ≤ g_{d1} and gₕ < gᵥ | Vertical flip |
| g_{d0} ≤ g_{d1} and gᵥ ≤ gₕ | Rotation |

### 1.3 ALF Process in VVC

At a decoder side, if a CTU-level ALF flag is true, each pixel R(i, j) in a current CTU will be filtered. The filtering process and output thereof are given by equation (11):

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad ( 11 )$$

where f(k,l) represents a filter tap coefficient, K(x, y) is a clipping function, and c(k, l) represents parameters related to a clipping operation. The values of k and 1 range from −L/2 to L/2, where Lis a filter length. A specific definition of the clipping function is K(x,y)=min (y,max(−y,x)). The clipping operation adds a nonlinear function to ALF, and can reduce the influence of pixels with excessively large differences from neighboring pixels on the current pixel.

### 2. ALF in Enhanced Compression Model (ECM)-8.0

ECM-8.0 removes a downsampling operation in gradient calculation and a virtual boundary constraint during an ALF classification process. For example, a basic unit of the ALF classification operation is changed from a 4×4 subblock to a 2×2 subblock. In addition, the shapes of luma and chroma filters are also modified accordingly.

### 2.1 Enhanced Fixed Filter

For a luma component, ECM-8.0 employs three different classifiers (C₀, C₁, and C₂) and three corresponding filter banks (F₀, F₁, and F₂). The filter banks F₀ and F₁ include fixed filters, and coefficients thereof are generated based on offline training of the classifiers C₀ and C₁. F₂ includes filter coefficients generated from to-be-coded content, which need to be written into the bitstream and transmitted to the decoder side.

### 2.2 Classification Process

In ECM-8.0, each 2×2 subblock generates a corresponding class index Dᵢ according to the directionality feature Âᵢ and activity feature Cᵢ thereof, as shown in equation (12):

$${C}_{i} = {\hat{A}}_{i} * {M}_{D , i} + {D}_{i} \qquad ( 12 )$$

where i represents the classifier index, and M_{D,i} represents the total number of activity features Dᵢ used by the corresponding classifier.

Similar to the calculation process in VVC, horizontal, vertical, diagonal, and anti-diagonal gradients of each pixel are generated using a 1-D Laplacian operator. For the classifier C₀, the gradient of a subblock is generated by summing pixel gradient values at all positions in a 4×4 region covering a target 2×2 subblock. For the classifiers C₁ and C₂, the gradient of a subblock is generated by summing pixel gradient values at all positions in a 12×12 region covering a target 2×2 subblock. The gradients of horizontal, vertical, diagonal, and anti-diagonal subblocks are specified into

$${g}_{h}^{i} , {g}_{v}^{i} , {g}_{d 1}^{i} , and {g}_{d 2}^{i} ,$$

respectively. The directionality feature Dᵢ is obtained by comparing the following two values with a set of thresholds:

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )}$$

The directionality feature D₂ uses the same thresholds 2 and 4.5 as in VVC. For D₀ and D₁, a horizontal/vertical edge strength

$${E}_{H V}^{i}$$

and a diagonal edge strength

$${E}_{D}^{i}$$

are first calculated. The threshold Th=[1.25, 1.5, 2, 3, 4.5, 8] is used. When

$${r}_{h , v}^{i} \leq Th [ 0 ] ,$$

the edge strength

$${E}_{HV}^{i}$$

is set to 0; otherwise,

$${E}_{H V}^{i}$$

is a maximum integer satisfying

$${r}_{h , v}^{i} > Th [ {E}_{H V}^{i} - 1 ] .$$

### When

$${r}_{d 1 , d 2}^{i} \leq Th [ 0 ] ,$$

the edge strength

$${E}_{D}^{i}$$

is set to 0; otherwise,

$${E}_{D}^{i}$$

is a maximum integer satisfying

$${r}_{d 1 , d 2}^{i} > Th [ {E}_{D}^{i} - 1 ] .$$

### When

$${r}_{h , v}^{i} > {r}_{d 1 , d 2}^{i} ,$$

e.g., the horizontal/vertical edge is strong, the directionality feature Dᵢ is generated according to Table 2-a. Otherwise, the directionality feature Dᵢ is generated according to Table 2-b.

TABLE 2-a

E_{D}ⁱ

| E_{HV}ⁱ | 0 | 1 | 2 | 3 | 4 | 5 | 6 |
|---|---|---|---|---|---|---|---|
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2-b

E_{HV}ⁱ

| E_{D}ⁱ | 0 | 1 | 2 | 3 | 4 | 5 | 6 |
|---|---|---|---|---|---|---|---|
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

The activity feature Âᵢ is generated by quantizing an accumulated result Aᵢ of horizontal and vertical gradients at a subblock level, with a quantized value ranging from 0 to n. For Â₂, n is set to 4. For Â₀ and Â₁, n is set to 15. One ALF_APS may transmit up to 4 luma component filter banks, with each filter bank including a maximum of 25 filters.

### 2.3 Classifier Based on 2×2 Subblocks

In ECM-8.0, a new classifier is adopted in the ALF classification process. For a filter bank transmitted to the decoder side, a flag is used for indicating whether the original classifier or the new classifier is used. Geometrical transformation is not applicable to the new classifier. When the new classifier is used, pixel values at all positions in a 2×2 subblock are summed, and classification is performed based on the sum of the pixel values.

$${class}_{i n d e x} = ( sum \times 25 ) >> ( sample bitdepth + 2 ) \qquad ( 13 )$$

### 2.4 Filtering Process

First, two fixed filters F₀ and F using 13×13 diamond-shaped filters generate two intermediate values R₀(x, y) and R₁(x, y) for a current to-be-filtered pixel. Then, a filter F₂ generated on line is applied to R₀(x, y), R₁(x, y), and neighboring pixels to generate a filtered pixel, as shown in equation (14):

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad ( 14 )$$

where f_{i,j} represents a difference between clipped neighboring pixels and a current pixel R(x, y), and gᵢ represents a difference between clipped Rᵢ₋₂₀(x, y) and the current pixel. A filter coefficient cᵢ, i=0, . . . 21, needs to be transmitted to the decoder side.

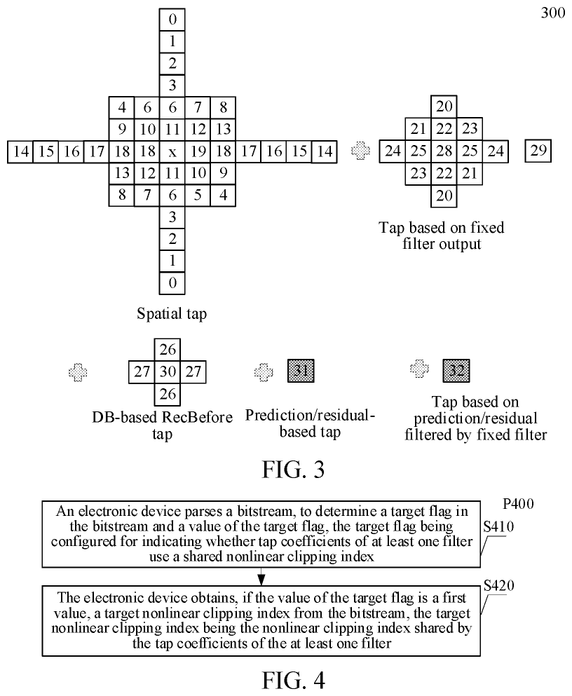

In ECM-8.0, a luma filter trained on line includes four types of inputs: spatial neighboring samples, reconstructed samples before deblocking, extended samples filtered by fixed filters, and residual components. The shape is as shown in FIG. 3. #0 to #19 represent the spatial neighboring samples. #20 to #25 and #28 to #29 represent the samples filtered by the fixed filters. #26, #27, and #30 represent the reconstructed samples before deblocking. #31 and #32 represent the residual components. Based on the plurality of input types, the filtering process is expressed as follows:

$$( 15 )$$

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{25} {c}_{i} ( {g}_{i , 0} + {g}_{i , 1} ) ] + [ {\sum }_{i = 26}^{27} {c}_{i} ( {h}_{i , 0} + {h}_{i , 1} ) ] + [ {\sum }_{i = 28}^{29} {c}_{i} {g}_{i} ] + [ {\sum }_{i = 30}^{30} {c}_{i} {h}_{i} ] + [ {\sum }_{i = 31}^{31} {c}_{i} {r}_{i} ] + [ {\sum }_{i = 32}^{32} {c}_{i} {rFilterd}_{i} ]$$

where f_{i,j} represents a difference between clipped spatial neighboring samples and the current sample R(x, y), gᵢ represents a difference between the clipped samples filtered by the fixed filters and the current sample R(x, y), and h_{i,j} represents a difference between the clipped reconstructed samples before deblocking and the current sample R(x, y). rᵢ represents the clipped residual component, and rFilteredᵢ represents the clipped residual component filtered by the fixed filters. The residual component and the reconstructed component share the same fixed filters.

In ALF_APS, a flag is used for indicating whether only residual components are used, or both residual components and residual components fixed by fixed filters are used.

### 2.5 Classifier Based on Residual Components

In JVET-AD0219, a new classifier based on luma residual components is proposed as a third classifier for ALF. For any 2×2 luma subblock, the sum sum of absolute residual values over an 8×8 region covering the current 2×2 subblock is first calculated, and classification is then performed based on the accumulated sum using the following equation:

$$classIdx = sum >> ( sample bit depth - 4 ) \qquad ( 16 )$$

A final class index classIdx ranges from 0 to 24. The classifier used for each filter bank is to be transmitted in ALF_APS.

### 3 ALF Nonlinear Clipping

As a linear filter, Wiener filter only considers a spatial similarity between adjacent pixels and a current to-be-processed pixel. To enable ALF to simultaneously consider the spatial similarity and a sample similarity between the adjacent pixels and the current to-be-processed pixel, ALF may use a nonlinear clipping operation. To be specific, a difference between an input of ALF and a current pixel is limited by means of clipping. The clipping function is as follows:

$${K}_{i} = min ( {b}_{i} , max ( - {b}_{i} , {diff}_{i} ) ) \qquad ( 17 )$$

where diffᵢ is a difference between an i^{th} input of ALF and the current pixel, and bᵢ is a nonlinear clipping value corresponding to the filter tap coefficient, determined by a nonlinear clipping index dᵢ. A correspondence between the nonlinear clipping index and nonlinear clipping in VVC and ECM is:

$${b}_{i} = \{ \begin{matrix}{2}^{BD} , when {d}_{i} = 0 \\ {2}^{BD - 1 - 2 {d}_{i}} , otherwise\end{matrix} \qquad ( 18 )$$

where BD represents a pixel bit depth, and dᵢ is the nonlinear clipping index, which may be 0, 1, 2, or 3.

In VVC and ECM, each tap coefficient of the filter has a corresponding nonlinear clipping index. If the coder side decides to use nonlinear clipping, all nonlinear clipping indexes are to be transmitted to the decoder side. The transmission process related to the nonlinear clipping indexes is shown in Table 3.

TABLE 3

| | Descriptor |
|---|---|
| alf_data( ) { | |
| ... | |
| if( alf_comp_filter_signal_flag ) { | |
| ... | |
| alf_comp_num_alt_filters_minus1 | |
| for(altIdx = 0; altIdx <= | |
| alf_comp_num_alt_filters_minus1; altIdx++){ | |
| alf_comp_clip_flag | |
| alf_comp_num_filters_signalled_minus1 | |
| ... | |
| if( alf_comp_clip_flag ) | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[alttIdx][ sfIdx ][ j ] | u(2) |
| ... | |
| } | |
| } | |
| } | |

alf_comp_num_alt_filters_minus1+1 indicates the number of different filter banks used for a current color component (in VVC, a luma component supports up to 1 filter bank, and a chroma component supports up to 8 filter banks; in ECM, a luma component supports up to 4 filter banks, and a chroma component supports up to 8 filter banks). For each filter bank, alf_comp_clip_flag is to indicate whether filters included in a current filter bank use nonlinear clipping. alf_comp_num_filters_signalled_minus1+1 indicates the number of filters included in the current filter bank (in VVC, one filter bank for the luma component includes up to 25 filters, and one filter bank for the chroma component includes up to 1 filter; in ECM, one filter bank for the luma component includes up to 25 filters, and one filter bank for the chroma component includes up to 1 filter). If nonlinear clipping is used, a nonlinear filter index is transmitted for each tap coefficient of the filter (in VVC, one filter for the luma component includes 13 tap coefficients, and one filter for the chroma component includes 7 tap coefficients; in ECM, one filter for the luma component includes 40 tap coefficients, and one filter for the chroma component includes 21 tap coefficients).

The nonlinear clipping in current ALF allows the Wiener filter to exploit spatial correlation while considering similarity to surrounding content. However, the corresponding nonlinear clipping indexes are to be transmitted for all tap coefficients of filters included in each filter bank. As a quantity of filter tap coefficients and a quantity of supportable filter banks are increased, bit overheads for transmitting the nonlinear clipping index of ALF are significantly increased, thereby affecting overall compression efficiency.

To solve the technical problems in the related art, embodiments of the present disclosure provide an enhanced ALF nonlinear clipping method using a shared nonlinear clipping index and a related nonlinear clipping index transmission method. These methods can improve the performance of ALF nonlinear clipping and help improve the overall compression efficiency of an electronic device (e.g., a coder or a coding device) configured to execute video coding tasks.

The technical solutions of some embodiments of the present disclosure are described in detail below with reference to several embodiments. The following several embodiments may be combined with each other, and the same or similar concepts or processes may not be described in detail in some embodiments.

### Embodiment 1

FIG. 4 is a schematic flowchart of a decoding method P400 according to some embodiments of the present disclosure. In the some embodiments, operations illustrated in FIG. 4 may be performed sequentially, in a different order, in parallel, or with some operations skipped or repeated. The decoding method P400 is performed by an electronic device. For example, the electronic device may be configured to execute a video decoding task, and may be exemplarily recorded as a decoder, a decoding device, or the like. Referring to FIG. 4, the method P400 includes:
S410: An electronic device parses a bitstream, to determine a target flag and a value of the target flag, the target flag being configured for indicating whether tap coefficients of at least one filter use a shared nonlinear clipping index.
S420: The electronic device obtains, if the value of the target flag is a first value, a target nonlinear clipping index from the bitstream, the target nonlinear clipping index being the nonlinear clipping index shared by the tap coefficients of the at least one filter.

By way of example, a preset mapping relationship exists between different nonlinear clipping indexes and different nonlinear clipping intervals. For example, four clipping indexes [0, 1, 2, 3] similar to a VTM or an ECM may be used, and absolute values of clipping intervals of the index association relationship are respectively [1024, 128, 32, 8]. To improve the fine degree, a quantity of clipping indexes may be increased according to an actual requirement. For example, eight clipping indexes [0, 1, 2, 3, 4, 5, 6, 7] are used, and absolute values of clipping intervals of the index association relationship may be [1024, 256, 128, 64, 32, 16, 8, 4].

By way of example, the nonlinear clipping index and the corresponding clipping interval may be transmitted in an HLS (a sequence parameter set (SPS), a picture parameter set (PPS), a video parameter set (VPS), an APS, a PictureHeader, a SliceHeader, or the like).

By way of example, whether to use the target nonlinear index for sharing provided in some embodiments of the present disclosure may be transmitted in the HLS (the SPS, the PPS, the VPS, the APS, the PictureHeader, the SliceHeader, or the like).

By way of example, after parsing the bitstream to determine the target nonlinear clipping index, the electronic device obtains a target nonlinear clipping interval having a mapping relationship with the target nonlinear clipping index, to perform a nonlinear clipping operation on an input of the at least one filter by using the target nonlinear clipping interval. Therefore, a difference between an input of ALF and a current pixel is limited by means of clipping. Further, ALF can consider a spatial similarity and a sample similarity between adjacent pixels and a current to-be-processed pixel. Some embodiments of the present disclosure provide an enhanced ALF nonlinear clipping method, which can improve performance of the ALF nonlinear clipping.

By way of example, the target nonlinear clipping index for sharing may be used for one or more of a chroma component, a luma component, or a cross-color component. For example, the index is separately used for the luma component or the chroma component. For example, the index may be simultaneously used for the luma component and the chroma component. For example, the index may be used in a case of the cross-color component (e.g., the chroma component is enhanced by using the luma component, a Cr component is enhanced by using a Cb component, and the Cb component is enhanced by using the Cr component).

Simultaneously may refer to two or more events, actions, or processes occurring at the same time, substantially at the same time, or within a sufficiently short time interval such that the events are perceived or functionally treated as occurring together.

In the solution provided by the method P400 according to the present disclosure, an electronic device configured to execute a video decoding task parses a bitstream to determine a value of a target flag. If the value of the target flag is a first value, it indicates that there is at least one filter having tap coefficients using a shared nonlinear clipping index. If the value of the target flag is not the first value, it indicates that there is no filter having tap coefficients using the shared nonlinear clipping index. Further, in a case that the value of the target flag is the first value, the electronic device further obtains a target nonlinear clipping index. The target nonlinear clipping index is the nonlinear clipping index shared by the tap coefficients of the at least one filter. In some embodiments of the present disclosure, nonlinear clipping indexes respectively corresponding to a plurality of tap coefficients of the at least one filter may be represented by one target nonlinear clipping index. For the same quantity of tap coefficients, a quantity of nonlinear clipping indexes can be reduced, so that bit overheads of the nonlinear clipping indexes can be effectively reduced, thereby facilitating improving video compression efficiency. For example, some embodiments of the present disclosure provide an enhanced ALF nonlinear clipping method, which can improve performance of the ALF nonlinear clipping.

### Embodiment 2

Based on Embodiment 1, Embodiment 2 of the present disclosure also provides a decoding method. All implementations recorded in Embodiment 1 may be applied to Embodiment 2, and can achieve the same technical effect.

As a specific implementation of S410, the target flag includes a first flag, the first flag being configured for indicating whether tap coefficients of all filters in a plurality of filter banks supporting sharing of a nonlinear clipping index use the shared nonlinear clipping index. By way of example, at a coder side, whether to use the shared nonlinear clipping index for the tap coefficients of all the filters in the plurality of supportable filter banks may be determined by using an RDO cost. When determining that the plurality of filter banks support tap coefficients of all filters to use the shared nonlinear clipping index, the coder determines a value of a first flag and writes the first flag and the value thereof into the bitstream. Therefore, the electronic device may obtain the value of the first flag by parsing the bitstream.

By way of example, the first flag may be represented as “alf_alt_share_nonlinear_flag”. If a value of alf_alt_share_nonlinear_flag is a second value (e.g., “0”), it indicates that the shared nonlinear clipping index is not used for the tap coefficients of all the filters in the plurality of filter banks. If the value of alf_alt_share_nonlinear_flag is a first value (e.g., “1”), it indicates that the shared nonlinear clipping index is used for the tap coefficients of all the filters in the plurality of filter banks.

As a specific implementation of S420, when the value of the first flag alf_alt_share_nonlinear_flag is a first value (e.g., “1”), the electronic device may parse the bitstream, to determine a first nonlinear clipping index, which is exemplarily represented as “alf_alt_shared_nonlinear_idx”. Therefore, the first nonlinear clipping index “alf_alt_shared_nonlinear_idx” may represent the nonlinear clipping index shared by the tap coefficients of all the filters in the plurality of filter banks.

In this exemplary embodiment, a transmission process of related syntax elements “alf_alt_share_nonlinear_flag” and “alf_alt_shared_nonlinear_idx” is shown in Table 4.

TABLE 4

| | Descriptor |
|---|---|
| alf_data( ) { | |
| ... | |
| if( alf_comp_filter_signal_flag ) { | |
| ... | |
| alf_comp_num_alt_filters_minus1 | |
| alf_alt_share_nonlinear_flag | |
| if (alf_alt_share_nonlinear_flag) | |
| alf_alt_shared_nonlinear_idx | |
| for(altIdx = 0; altIdx <= | |
| alf_comp_num_alt_filters_minus1; altIdx++){ | |
| alf_comp_clip_flag | |
| alf_comp_num_filters_signalled_minus1 | |
| ... | |
| if( alf_comp_clip_flag && ! | |
| alf_alt_share_nonlinear_flag ) | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | u(2) |
| ... | |
| } | |
| } | |
| } | |

Referring to Table 4, the electronic device first parses alf_alt_share_nonlinear_flag (first flag). If a value of the syntax element is a first value (e.g., “1”), which indicates that tap coefficients of all filters in a plurality of filter banks use the shared nonlinear clipping index, the electronic device further parses alf_alt_shared_nonlinear_idx (first nonlinear clipping index), to obtain the nonlinear clipping index shared by the tap coefficients of all the filters in the plurality of filter banks. In this case, for the plurality of filter banks, only one shared nonlinear clipping index needs to be transmitted, to implement a nonlinear clipping operation on inputs of all the filters in the plurality of filter banks. Therefore, bit overheads of the nonlinear clipping indexes can be significantly reduced, thereby facilitating improving video compression efficiency.

By way of example, when a filter bank uses nonlinear clipping and the value of alf_alt_share_nonlinear_flag (first flag) is a second value (e.g., “0”), the electronic device needs to parse a corresponding nonlinear clipping index for each tap coefficient.

### Embodiment 3

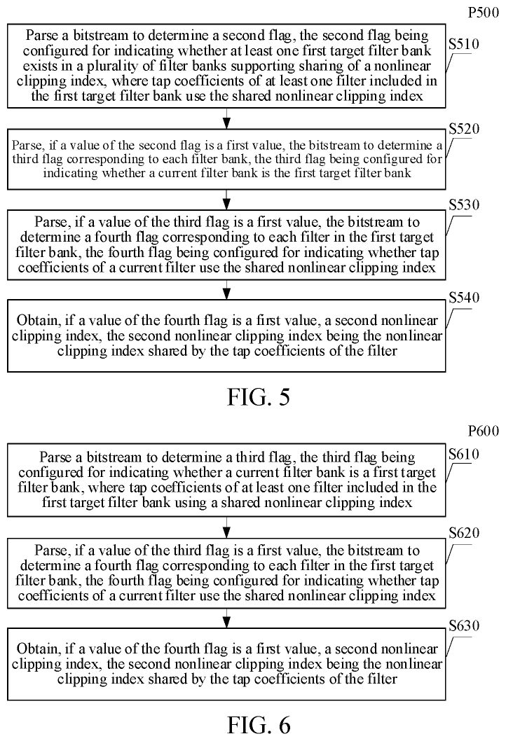

Based on Embodiment 1, Embodiment 3 of the present disclosure also provides a decoding method P500. All implementations recorded in Embodiment 1 may be applied to Embodiment 3, and can achieve the same technical effect. FIG. 5 is a schematic flowchart of a decoding method P500 according to some embodiments of the present disclosure. In the some embodiments, operations illustrated in FIG. 5 may be performed sequentially, in a different order, in parallel, or with some operations skipped or repeated

As a specific implementation of S410, S510 includes: parsing a bitstream to determine a second flag, the second flag being configured for indicating whether at least one first target filter bank exists in a plurality of filter banks supporting sharing of a nonlinear clipping index, where tap coefficients of at least one filter included in the first target filter bank use the shared nonlinear clipping index.

In this embodiment, the target flag includes a second flag, the second flag being configured for indicating whether at least one first target filter bank exists in a plurality of filter banks supporting sharing of a nonlinear clipping index, where tap coefficients of at least one filter included in the first target filter bank use the shared nonlinear clipping index. By way of example, at a coder side, whether the first target filter bank exists in the plurality of filter banks may be determined by using an RDO cost. When determining that the first target filter bank exists in the plurality of filter banks supporting sharing of the nonlinear clipping index, the coder determines a value of a second flag and writes the second flag and the value thereof into the bitstream. Therefore, the electronic device configured to execute a video decoding task may obtain the value of the second flag by parsing the bitstream.

By way of example, the second flag may be represented as “alf_alt_has_filter_share_nonlinear”. If a value of alf_alt_has_filter_share_nonlinear is a second value (e.g., “0”), it indicates that none of a plurality of filter banks supporting sharing of a nonlinear clipping index shares the nonlinear clipping index. If the value of alf_alt_has_filter_share_nonlinear is a first value (e.g., “1”), it indicates that the at least one first target filter bank exists in the plurality of filter banks.

As a specific implementation of S420, S520 to S540 are performed.
S520: Parse, if a value of the second flag is a first value, the bitstream to determine a third flag corresponding to each filter bank, the third flag being configured for indicating whether a current filter bank is the first target filter bank.

As described above, if the value of the second flag alf_alt_has_filter_share_nonlinear is a first value (e.g., “1”), it indicates that the at least one first target filter bank exists in the plurality of (e.g., N) filter banks. Further, to further determine which filter bank belongs to the first target filter bank, the electronic device needs to determine a third flag corresponding to an i^{th} (i is an integer having a value of 1 to N in sequence) filter bank among the N filter banks. The third flag of the i^{th} filter bank is configured for indicating whether the i^{th} filter bank is the first target filter bank. To be specific, tap coefficients of at least one filter included in the i^{th} filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S530: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

As described above, if the value of the third flag alf_filterset_has_filter_share_nonlinear is a first value (e.g., “1”), it indicates that a current filter bank belongs to the first target filter bank. To be specific, tap coefficients of at least one filter included in the current filter bank use the shared nonlinear clipping index. Further, to further determine which filter in the first target filter bank has tap coefficients sharing the nonlinear clipping index, a value of a fourth flag corresponding to each filter in the first target filter bank needs to be determined. Assuming that the first target filter bank currently includes M filters, a fourth flag of a j^{th} filter (j is an integer having a value of 1 to M in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S540: Obtain, if a value of the fourth flag is a first value, a second nonlinear clipping index, the second nonlinear clipping index being the nonlinear clipping index shared by the tap coefficients of the filter.

As described above, if the value of the fourth flag alf_filter_share_nonlinear is a first value (e.g., “1”), it indicates that tap coefficients of a current filter use the shared nonlinear clipping index. To be specific, a filter having tap coefficient using the shared nonlinear clipping index is determined. Further, the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the determined filter.

In this exemplary embodiment, a transmission process of related syntax elements is shown in Table 5.

TABLE 5

| | |
|---|---|
| alf_data( ) { | Descriptor |
| ... | |
| if( alf_comp_filter_signal_flag ) { | |
| ... | |
| alf_comp_num_alt_filters_minus1 | |
| alf_alt_has_filter_share_nonlinear | |
| for(altIdx = 0; altIdx <= alf_comp_num_alt_filters_minus1; | |
| altIdx++){ | |
| alf_comp_clip_flag | |
| alf_comp_num_filters_signalled_minus1 | |
| ... | |
| if( alf_comp_clip_flag ) | |
| if (alf_alt_has_filter_share_nonlinear){ | |
| alf_filterset_has_filter_share_nonlinear[altIdx] | |
| if (alf_filterset_has_filter_share_nonlinear[altIdx]){ | |
| for( sfIdx = 0; sfIdx <= | |
| alf_comp_num_filters_signalled_minus1; sfIdx++ ) | |
| alf_filter_share_nonlinear_flag[altIdx][sfIdx] | |
| if(alf_filter_share_nonlinear_flag[altIdx][sfIdx]) { | |
| alf_filter_shared_nonlinear_idx[altIdx][sfIdx] | |
| } | |
| else { | |
| for( j = 0; j < filter_tap_num; j++ ) | |
| alf_comp_clip_idx[altIdx][ sfIdx ][ j ] | |
| } | |
| } | |
| else { | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | |
| } | |
| } | |
| else { | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | u(2) |
| } | |
| ... | |
| } | |
| } | |
| } | |

Referring to Table 5, the electronic device first parses alf_alt_has_filter_share_nonlinear (second flag). If a value of the syntax element is a first value (e.g., “1”), it indicates that the at least one first target filter bank exists in the plurality of filter banks. Further, to determine which filter bank belongs to the first target filter bank, the electronic device parses alf_filterset_has_filter_share_nonlinear (third flag). If a value of the syntax element is a first value (e.g., “1”), it indicates that a current filter bank belongs to the first target filter bank. To be specific, tap coefficients of at least one filter included in the current filter bank use the shared nonlinear clipping index. To further determine which filter in the first target filter bank has tap coefficients sharing the nonlinear clipping index, the electronic device parses alf_filter_share_nonlinear (fourth flag). If a value of the syntax element is a first value (e.g., “1”), which indicates that tap coefficients of a current filter use the shared nonlinear clipping index, the electronic device further parses alf_filter_shared_nonlinear_idx (second nonlinear clipping index), so that the tap coefficients of the determined filter use the shared nonlinear clipping index. In this case, for the plurality of tap coefficients of the determined filter, only one shared nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 4

Based on Embodiment 1, Embodiment 4 of the present disclosure also provides a decoding method P600. All implementations recorded in Embodiment 1 may be applied to Embodiment 4, and can achieve the same technical effect. FIG. 6 is a schematic flowchart of a decoding method P600 according to some embodiments of the present disclosure. In the some embodiments, operations illustrated in FIG. 6 may be performed sequentially, in a different order, in parallel, or with some operations skipped or repeated

As a specific implementation of S410, S610 includes: parsing a bitstream to determine a third flag, the target flag being configured for indicating whether a current filter bank is a first target filter bank, where tap coefficients of at least one filter included in the first target filter bank using a shared nonlinear clipping index.

In this embodiment, the target flag includes a third flag, the third flag being configured for indicating whether a current filter bank is a first target filter bank, where tap coefficients of at least one filter included in the first target filter bank use the shared nonlinear clipping index. By way of example, at a coder side, whether a current filter bank belongs to the first target filter bank may be determined by using an RDO cost. When determining that the first target filter bank exists in the current filter bank, the coder determines a value of a third flag and writes the third flag and the value thereof into the bitstream. Therefore, the electronic device configured to execute a video decoding task may obtain the value of the third flag by parsing the bitstream.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.

As a specific implementation of S420, S620 to S630 are performed.
S620: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

As described above, if the value of the third flag alf_filterset_has_filter_share_nonlinear is a first value (e.g., “1”), it indicates that a current filter bank belongs to the first target filter bank. To be specific, tap coefficients of at least one filter included in the current filter bank use the shared nonlinear clipping index. Further, to further determine which filter in the first target filter bank has tap coefficients sharing the nonlinear clipping index, a value of a fourth flag corresponding to each filter in the first target filter bank needs to be determined. Assuming that the first target filter bank currently includes M filters, a fourth flag of a j^{th} filter (j is an integer having a value of 1 to M in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.

S630: Obtain, if a value of the fourth flag is a first value, a second nonlinear clipping index, the second nonlinear clipping index being the nonlinear clipping index shared by the tap coefficients of the filter.

As described above, if the value of the fourth flag alf_filter_share_nonlinear is a first value (e.g., “1”), it indicates that tap coefficients of a current filter use the shared nonlinear clipping index. To be specific, a filter having tap coefficient using the shared nonlinear clipping index is determined. Further, the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the determined filter.

In this exemplary embodiment, a transmission process of related syntax elements is shown in Table 6.

TABLE 6

| | Descriptor |
|---|---|
| alf_data( ) { | |
| ... | |
| if( alf_comp_filter_signal_flag ) { | |
| ... | |
| alf_comp_num_alt_filters_minus1 | |
| for(altIdx = 0; altIdx <= alf_comp_num_alt_filters_minus1; | |
| altIdx++){ | |
| alf_comp_clip_flag | |
| alf_comp_num_filters_signalled_minus1 | |
| ... | |
| if( alf_comp_clip_flag ) | |
| alf_filterset_has_filter_share_nonlinear[altIdx] | |
| if (alf_filterset_has_filter_share_nonlinear[atIdx]){ | |
| for( sfIdx = 0; sfIdx <= | |
| alf_comp_num_filters_signalled_minus1; sfIdx++ ) | |
| alf_filter_share_nonlinear_flag[altIdx][sfIdx] | |
| if (alf_filter_share_nonlinear_flag[altIdx][sfIdx]){ | |
| alf_filter_shared_nonlinear_idx[altIdx][sfIdx] | |
| } | |
| else { | |
| for( j = 0; j < filter_tap_num; j++ ) | |
| alf_comp_clip_idx[altIdx][ sfIdx ][ j ] | u(2) |
| } | |
| } | |
| else { | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | |
| } | |
| ... | |
| } | |
| } | |
| } | |

Referring to Table 6, the electronic device first parses alf_filterset_has_filter_share_nonlinear (third flag). If a value of the syntax element is a first value (e.g., “1”), it indicates that a current filter bank belongs to the first target filter bank. To be specific, tap coefficients of at least one filter included in the current filter bank use the shared nonlinear clipping index. To further determine which filter in the first target filter bank has tap coefficients sharing the nonlinear clipping index, the electronic device parses alf_filter_share_nonlinear (fourth flag). If a value of the syntax element is a first value (e.g., “1”), which indicates that tap coefficients of a current filter use the shared nonlinear clipping index, the electronic device further parses alf_filter_shared_nonlinear_idx (second nonlinear clipping index), so that the tap coefficients of the determined filter use the shared nonlinear clipping index. In this case, for the plurality of tap coefficients of the determined filter, only one shared nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 5

Based on Embodiment 1, Embodiment 5 of the present disclosure also provides a decoding method. All implementations recorded in Embodiment 1 may be applied to Embodiment 5, and can achieve the same technical effect.

As a specific implementation of S410, the target flag includes a fourth flag, the fourth flag being configured for indicating whether tap coefficients of a current filter use the shared nonlinear clipping index. By way of example, at a coder side, whether to use the shared nonlinear clipping index for tap coefficients of a current filter may be determined by using an RDO cost. When determining that the tap coefficients of the current filter use the shared nonlinear clipping index, the coder determines a value of a fourth flag and writes the fourth flag and the value thereof into the bitstream. Therefore, the electronic device configured to execute a video decoding task may obtain the value of the fourth flag by parsing the bitstream.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.

As a specific implementation of S420, when the value of the fourth flag alf_filter_share_nonlinear is a first value (e.g., “1”), the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the current filter.

In this exemplary embodiment, a transmission process of related syntax elements is shown in Table 7.

TABLE 7

| | Descriptor |
|---|---|
| alf_data( ) { | |
| ... | |
| if( alf_comp_filter_signal_flag ) { | |
| ... | |
| alf_comp_num_alt_filters_minus1 | |
| for(altIdx = 0; altIdx <= alf_comp_num_alt_filters_minus1; | |
| altIdx++){ | |
| alf_comp_clip_flag | |
| alf_comp_num_filters_signalled_minus1 | |
| ... | |
| if( alf_comp_clip_flag ) | |
| for( sfIdx = 0; sfIdx <= | |
| alf_comp_num_filters_signalled_minus1; sfIdx++ ) | |
| alf_filter_share_nonlinear_flag[altIdx][sfIdx] | |
| if (alf_filter_share_nonlinear_flag[altIdx][sfIdx]){ | |
| alf_filter_shared_nonlinear_idx[altIdx][sfIdx] | |
| } | |
| else { | |
| for( j = 0; j < filter_tap_num; j++ ) | |
| alf_comp_clip_idx[altIdx][ sfIdx ][ j ] | u(2) |
| } | |
| ... | |
| } | |
| } | |
| } | |

Referring to Table 7, the electronic device first parses alf_filter_share_nonlinear (fourth flag). If a value of the syntax element is a first value (e.g., “1”), which indicates that tap coefficients of a current filter use the shared nonlinear clipping index, the electronic device further parses alf_filter_shared_nonlinear_idx (second nonlinear clipping index), so that the tap coefficients of the current filter use the shared nonlinear clipping index. In this case, for the plurality of tap coefficients of the filter, only one shared nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 6

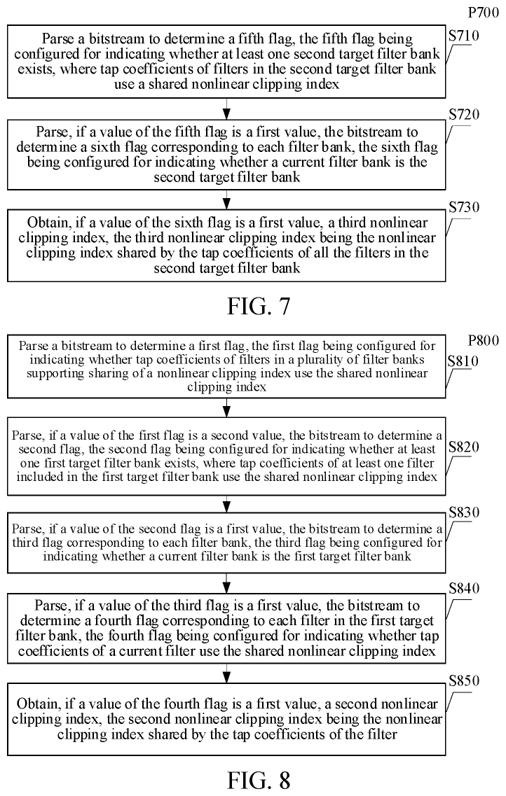

Based on Embodiment 1, Embodiment 6 of the present disclosure also provides a decoding method P700. All implementations recorded in Embodiment 1 may be applied to Embodiment 6, and can achieve the same technical effect. FIG. 7 is a schematic flowchart of a decoding method P700 according to some embodiments of the present disclosure. In the some embodiments, operations illustrated in FIG. 7 may be performed sequentially, in a different order, in parallel, or with some operations skipped or repeated

As a specific implementation of S410, S710 includes: parsing a bitstream to determine a fifth flag, the fifth flag being configured for indicating whether at least one second target filter bank exists, where tap coefficients of filters in the second target filter bank use a shared nonlinear clipping index.

In this embodiment, the target flag includes a fifth flag, the fifth flag being configured for indicating whether at least one second target filter bank exists in a plurality of filter banks supporting sharing of a nonlinear clipping index, where tap coefficients of filters in the second target filter bank use the shared nonlinear clipping index. By way of example, at a coder side, whether the second target filter bank exists in the plurality of filter banks may be determined by using an RDO cost. When determining that the second target filter bank exists in the plurality of filter banks supporting sharing of the nonlinear clipping index, the coder determines a value of a fifth flag and writes the fifth flag and the value thereof into the bitstream. Therefore, the electronic device may obtain the value of the fifth flag by parsing the bitstream.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. No additional syntax elements related to the shared nonlinear index need to be transmitted. If the value of alf_has_filterset_share_nonlinear is a first value (e.g., “1”), it indicates that the at least one second target filter bank exists in the plurality of filter banks.

As a specific implementation of S420, S720 to S730 are performed.
S720: Parse, if a value of the fifth flag is a first value, the bitstream to determine a sixth flag corresponding to each filter bank, the sixth flag being configured for indicating whether a current filter bank is the second target filter bank.

As described above, if the value of the fifth flag alf_has_filterset_share_nonlinear is a first value (e.g., “1”), it indicates that the at least one second target filter bank exists in the plurality of (e.g., L) filter banks. Further, to further determine which filter bank belongs to the second target filter bank, it is necessary to determine a sixth flag corresponding to an i^{th} (i is an integer having a value of 1 to L in sequence) filter bank among the L filter banks. The sixth flag of the i^{th} filter bank is configured for indicating whether the i^{th} filter bank is the second target filter bank. To be specific, tap coefficients of filters in the i^{th} filter bank use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index. If the value of alf_filterset_share_nonlinear_flag is a first value (e.g., “1”), it indicates that the current filter bank belongs to the second target filter bank. To be specific, tap coefficients of filters in the current filter bank use the shared nonlinear clipping index.
S730: Obtain, if a value of the sixth flag is a first value, a third nonlinear clipping index, the third nonlinear clipping index being the nonlinear clipping index shared by the tap coefficients of the filters in the second target filter bank.

As described above, if the value of the sixth flag alf_filterset_share_nonlinear_flag is a first value (e.g., “1”), it indicates that tap coefficients of filters in a current filter bank use the shared nonlinear clipping index. To be specific, a filter having tap coefficient using the shared nonlinear clipping index is determined. Further, the electronic device may parse the bitstream, to determine a third nonlinear clipping index, which is exemplarily represented as “alf_filterset_shared_nonlinear_idx”. Therefore, the third nonlinear clipping index “alf_filterset_shared_nonlinear_idx” may represent the nonlinear clipping index shared by the tap coefficients of the determined filter.

In this exemplary embodiment, a transmission process of related syntax elements is shown in Table 8.

TABLE 8

| | Descriptor |
|---|---|
| alf_data( ) { | |
| ... | |
| if( alf_comp_filter_signal_flag ) { | |
| ... | |
| alf_comp_num_alt_filters_minus1 | |
| alf_has_filterset_share_nonlinear | |
| for(altIdx = 0; altIdx <= | |
| alf_comp_num_alt_filters_minus1; altIdx++){ | |
| alf_comp_clip_flag | |
| alf_comp_num_filters_signalled_minus1 | |
| ... | |
| if( alf_comp_clip_flag ) | |
| if( alf_has_filterset_share_nonlinear) { | |
| alf_filterset_share_nonlinear_flag[altIdx] | |
| if (alf_filterset_share_nonlinear_flag[altIdx]) | |
| alf_filterset_shared_nonlinear_idx[altIdx] | |
| else{ | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | u(2) |
| } | |
| } | |
| else { | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | u(2) |
| } | |
| ... | |
| } | |
| } | |
| } | |

Referring to Table 8, the electronic device first parses alf_has_filterset_share_nonlinear (fifth flag). If a value of the syntax element is a first value (e.g., “1”), it indicates that at least one second target filter bank exists in the L filter banks. To be specific, all tap coefficients of at least one filter bank included in the L filter banks use the shared nonlinear clipping index. Further, to determine which filter bank belongs to the second target filter bank, the electronic device parses alf_filterset_share_nonlinear_flag (sixth flag). If a value of the syntax element is a first value (e.g., “1”), it indicates that a current filter bank belongs to the second target filter bank. To be specific, tap coefficients of all filters in the current filter bank use the shared nonlinear clipping index. The electronic device further parses alf_filterset_shared_nonlinear_idx (third nonlinear clipping index), to obtain the nonlinear clipping index shared by the tap coefficients of all the filters in the second target filter bank. In this case, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 7

Based on Embodiment 1, Embodiment 7 of the present disclosure also provides a decoding method. All implementations recorded in Embodiment 1 may be applied to Embodiment 7, and can achieve the same technical effect.

As a specific implementation of S410, the target flag includes a sixth flag, the sixth flag being configured for indicating whether a current filter bank is a second target filter bank, where tap coefficients of filters in the second target filter bank use the shared nonlinear clipping index. By way of example, at a coder side, whether to use the shared nonlinear clipping index for tap coefficients of all filters in a current filter bank may be determined by using an RDO cost. When determining that the tap coefficients of all the filters in the current filter bank use the shared nonlinear clipping index, the coder determines a value of a sixth flag and writes the sixth flag and the value thereof into the bitstream. Therefore, the electronic device may obtain the value of the sixth flag by parsing the bitstream.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index. If the value of alf_filterset_share_nonlinear_flag is a first value (e.g., “1”), it indicates that the current filter bank belongs to the second target filter bank. To be specific, tap coefficients of all filters in the current filter bank use the shared nonlinear clipping index.

As a specific implementation of S420, when the value of the sixth flag alf_filterset_share_nonlinear_flag is a first value (e.g., “1”), the electronic device may parse the bitstream, to determine a third nonlinear clipping index, which is exemplarily represented as “alf_filterset_shared_nonlinear_idx”. Therefore, the third nonlinear clipping index “alf_filterset_shared_nonlinear_idx” may represent the nonlinear clipping index shared by the tap coefficients of all the filters in the current filter bank.

In this exemplary embodiment, a transmission process of related syntax elements is shown in Table 9.

TABLE 9

| | Descriptor |
|---|---|
| alf_data( ) { | |
| ... | |
| if( alf_comp_filter_signal_flag ) { | |
| ... | |
| alf_comp_num_alt_filters_minus1 | |
| for(altIdx = 0; altIdx <= | |
| alf_comp_num_alt_filters_minus1; altIdx++){ | |
| alf_comp_clip_flag | |
| alf_comp_num_filters_signalled_minus1 | |
| ... | |
| if( alf_comp_clip_flag ) | |
| alf_filterset_share_nonlinear_flag[altIdx] | |
| if (alf_filterset_share_nonlinear_flag[altIdx]) { | |
| alf_filterset_shared_nonlinear_idx[altIdx] | |
| } | |
| else { | |
| for( sfIdx = 0; sfIdx <= | |
| alf_comp_num_filters_signalled_minus1; sfIdx++ ) | |
| for( j = 0; j < filter_tap_num; j++ ) | |
| alf_comp_clip_idx[altIdx][ sfIdx ][ j ] | u(2) |
| } | |
| ... | |
| } | |
| } | |
| } | |

Referring to Table 9, the electronic device first parses alf_filterset_share_nonlinear_flag (sixth flag). If a value of the syntax element is a first value (e.g., “1”), it indicates that a current filter bank belongs to the second target filter bank. To be specific, tap coefficients of all filters in the current filter bank use the shared nonlinear clipping index. The electronic device further parses alf_filterset_shared_nonlinear_idx (third nonlinear clipping index), to obtain the nonlinear clipping index shared by the tap coefficients of all the filters in the current filter bank. In this case, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 8

Based on Embodiment 1, Embodiment 8 of the present disclosure also provides a decoding method P800. All implementations recorded in Embodiment 1 may be applied to Embodiment 8, and can achieve the same technical effect. FIG. 8 is a schematic flowchart of a decoding method P800 according to some embodiments of the present disclosure. In the some embodiments, operations illustrated in FIG. 8 may be performed sequentially, in a different order, in parallel, or with some operations skipped or repeated. Referring to FIG. 8, the method P800 includes S810 to S850.

As a specific implementation of S410, S810 includes: parsing a bitstream to determine a first flag, the first flag being configured for indicating whether tap coefficients of filters in a plurality of filter banks supporting sharing of a nonlinear clipping index use the shared nonlinear clipping index.

The target flag includes a first flag, the first flag being configured for indicating whether tap coefficients of filters in a plurality of filter banks supporting sharing of a nonlinear clipping index use the shared nonlinear clipping index. By way of example, at a coder side, whether to use the shared nonlinear clipping index for the tap coefficients of all the filters in the plurality of supportable filter banks may be determined by using an RDO cost. When determining that the plurality of filter banks support tap coefficients of all filters to use the shared nonlinear clipping index, the coder determines a value of a first flag and writes the first flag and the value thereof into the bitstream. Therefore, the electronic device may obtain the value of the first flag by parsing the bitstream.

By way of example, the first flag may be represented as “alf_alt_share_nonlinear_flag”. If a value of alf_alt_share_nonlinear_flag is a second value (e.g., “0”), it indicates that the shared nonlinear clipping index is not used for the tap coefficients of all the filters in the plurality of filter banks. If the value of alf_alt_share_nonlinear_flag is a first value (e.g., “1”), it indicates that the shared nonlinear clipping index is used for the tap coefficients of all the filters in the plurality of filter banks.

As a specific implementation of S420, S820 to S850 are performed.
S820: Parse, if a value of the first flag is a second value, the bitstream to determine a second flag, the second flag being configured for indicating whether at least one first target filter bank exists, where tap coefficients of at least one filter included in the first target filter bank use the shared nonlinear clipping index.

As described above, if the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether a first target filter bank exists, where tap coefficients of at least one filter included in the first target filter bank use the shared nonlinear clipping index.

By way of example, the electronic device parses the bitstream to determine a value of a second flag. The second flag is configured for indicating whether at least one first target filter bank exists, where tap coefficients of at least one filter included in the first target filter bank use the shared nonlinear clipping index. By way of example, at a coder side, whether the first target filter bank exists in the plurality of filter banks may be determined by using an RDO cost. When determining that the first target filter bank exists in the plurality of filter banks supporting sharing of the nonlinear clipping index, the coder determines a value of a second flag and writes the second flag and the value thereof into the bitstream. Therefore, the electronic device may obtain the value of the second flag by parsing the bitstream.

By way of example, the second flag may be represented as “alf_alt_has_filter_share_nonlinear”. If a value of alf_alt_has_filter_share_nonlinear is a second value (e.g., “0”), it indicates that none of a plurality of filter banks supporting sharing of a nonlinear clipping index shares the nonlinear clipping index. If the value of alf_alt_has_filter_share_nonlinear is a first value (e.g., “1”), it indicates that the at least one first target filter bank exists in the plurality of filter banks.
S830: Parse, if a value of the second flag is a first value, the bitstream to determine a third flag corresponding to each filter bank, the third flag being configured for indicating whether a current filter bank is the first target filter bank.

A specific implementation of S830 is the same as that of S520. Details are not described herein again.
S840: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

A specific implementation of S840 is the same as that of S530. Details are not described herein again.
S850: Obtain, if a value of the fourth flag is a first value, a second nonlinear clipping index, the second nonlinear clipping index being the nonlinear clipping index shared by the tap coefficients of the filter.

A specific implementation of S850 is the same as that of S540. Details are not described herein again.

In the solution provided in Embodiment 8, for the plurality of tap coefficients of the determined filter, only one shared second nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 9

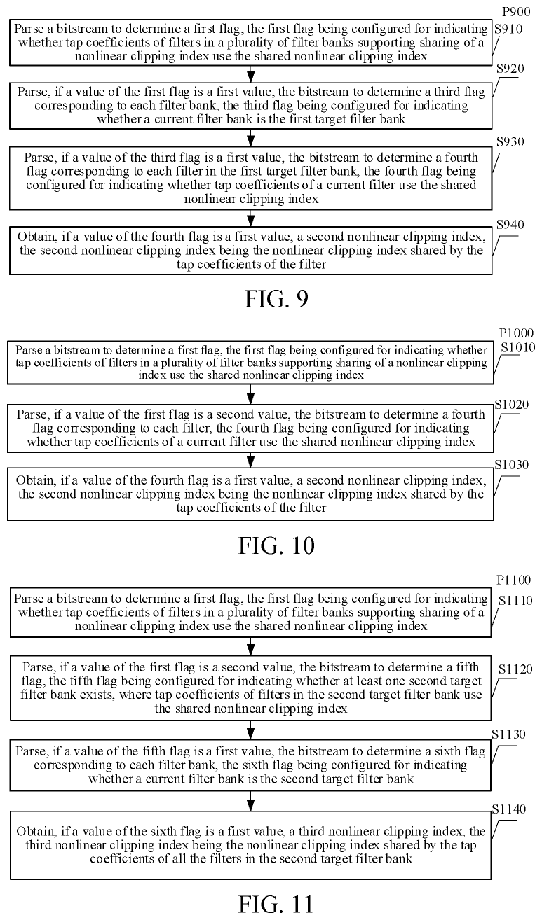

Based on Embodiment 1, Embodiment 9 of the present disclosure also provides a decoding method P900. All implementations recorded in Embodiment 1 may be applied to Embodiment 9, and can achieve the same technical effect. FIG. 9 is a schematic flowchart of a decoding method P900 according to some embodiments of the present disclosure. In the some embodiments, operations illustrated in FIG. 9 may be performed sequentially, in a different order, in parallel, or with some operations skipped or repeated. Referring to FIG. 9, the method P900 includes S910 to S940.

As a specific implementation of S410, S910 includes: parsing a bitstream to determine a first flag, the first flag being configured for indicating whether tap coefficients of filters in a plurality of filter banks supporting sharing of a nonlinear clipping index use the shared nonlinear clipping index.

A specific implementation of S910 is the same as that of S810. Details are not described herein again.

As a specific implementation of S420, S920 to S940 are performed.
S920: Parse, if a value of the first flag is a second value, the bitstream to determine a third flag corresponding to each filter bank, the third flag being configured for indicating whether a current filter bank is a first target filter bank, where tap coefficients of at least one filter included in the first target filter bank use the shared nonlinear clipping index.

If the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether a current filter bank belongs to a first target filter bank, where tap coefficients of at least one filter included in the first target filter bank use the shared nonlinear clipping index.

By way of example, the electronic device parses the bitstream to determine a value of a third flag. The third flag is configured for indicating whether a current filter bank is a first target filter bank, where tap coefficients of at least one filter included in the first target filter bank use the shared nonlinear clipping index. By way of example, at a coder side, whether a current filter bank belongs to the first target filter bank may be determined by using an RDO cost. When determining that the first target filter bank exists in the current filter bank, the coder determines a value of a third flag and writes the third flag and the value thereof into the bitstream. Therefore, the electronic device may obtain the value of the third flag by parsing the bitstream.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S930: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

A specific implementation of S930 is the same as that of S620. Details are not described herein again.
S940: Obtain, if a value of the fourth flag is a first value, a second nonlinear clipping index, the second nonlinear clipping index being the nonlinear clipping index shared by the tap coefficients of the filter.

A specific implementation of S940 is the same as that of S630. Details are not described herein again.

In the solution provided in Embodiment 9, for the plurality of tap coefficients of the determined filter, only one shared second nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 10

Based on Embodiment 1, Embodiment 10 of the present disclosure also provides a decoding method P1000. All implementations recorded in Embodiment 1 may be applied to Embodiment 10, and can achieve the same technical effect. FIG. 10 is a schematic flowchart of a decoding method P1000 according to some embodiments of the present disclosure. In the some embodiments, operations illustrated in FIG. 10 may be performed sequentially, in a different order, in parallel, or with some operations skipped or repeated. Referring to FIG. 10, the method P1000 includes S1010 to S1030.

As a specific implementation of S410, S1010 includes: parsing a bitstream to determine a first flag, the first flag being configured for indicating whether tap coefficients of filters in a plurality of filter banks supporting sharing of a nonlinear clipping index use the shared nonlinear clipping index.

A specific implementation of S1010 is the same as that of S810. Details are not described herein again.

As a specific implementation of S420, S1020 to S1030 are performed.
S1020: Parse, if a value of the first flag is a second value, the bitstream to determine a fourth flag corresponding to each filter, the fourth flag being configured for indicating whether tap coefficients of a current filter use the shared nonlinear clipping index.

If the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether tap coefficients of a current filter use the shared nonlinear clipping index.

By way of example, the electronic device parses the bitstream to determine a value of a fourth flag. The fourth flag is configured for indicating whether tap coefficients of a current filter use the shared nonlinear clipping index. By way of example, at a coder side, whether to use the shared nonlinear clipping index for tap coefficients of a current filter may be determined by using an RDO cost. When determining that the tap coefficients of the current filter use the shared nonlinear clipping index, the coder determines a value of a fourth flag and writes the fourth flag and the value thereof into the bitstream. Therefore, the electronic device may obtain the value of the fourth flag by parsing the bitstream.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S1030: Obtain, if a value of the fourth flag is a first value, a second nonlinear clipping index, the second nonlinear clipping index being the nonlinear clipping index shared by the tap coefficients of the filter.

When the value of the fourth flag alf_filter_share_nonlinear is a first value (e.g., “1”), the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the current filter.

In the solution provided in Embodiment 10, for the plurality of tap coefficients of the determined filter, only one shared second nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 11

Based on Embodiment 1, Embodiment 11 of the present disclosure also provides a decoding method P1100. All implementations recorded in Embodiment 1 may be applied to Embodiment 11, and can achieve the same technical effect. FIG. 11 is a schematic flowchart of a decoding method P1100 according to some embodiments of the present disclosure. In the some embodiments, operations illustrated in FIG. 11 may be performed sequentially, in a different order, in parallel, or with some operations skipped or repeated. Referring to FIG. 11, the method P1100 includes S1110 to S1140.

As a specific implementation of S410, S1110 includes: parsing a bitstream to determine a first flag, the first flag being configured for indicating whether tap coefficients of filters in a plurality of filter banks supporting sharing of a nonlinear clipping index use the shared nonlinear clipping index.

A specific implementation of S1110 is the same as that of S810. Details are not described herein again.

As a specific implementation of S420, S1120 to S1140 are performed.
S1120: Parse, if a value of the first flag is a second value, the bitstream to determine a fifth flag, the fifth flag being configured for indicating whether at least one second target filter bank exists, where tap coefficients of filters in the second target filter bank use the shared nonlinear clipping index.

If the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether a second target filter bank exists in the plurality of filter banks, where tap coefficients of filters in the second target filter bank use the shared nonlinear clipping index.

By way of example, the electronic device parses the bitstream to determine a value of a fifth flag. By way of example, at a coder side, whether the second target filter bank exists in the plurality of filter banks may be determined by using an RDO cost. When determining that the second target filter bank exists in the plurality of filter banks supporting sharing of the nonlinear clipping index, the coder determines a value of a fifth flag and writes the fifth flag and the value thereof into the bitstream. Therefore, the electronic device may obtain the value of the fifth flag by parsing the bitstream.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. No additional syntax elements related to the shared nonlinear index need to be transmitted. If the value of alf_has_filterset_share_nonlinear is a first value (e.g., “1”), it indicates that the at least one second target filter bank exists in the plurality of filter banks.
S1130: Parse, if a value of the fifth flag is a first value, the bitstream to determine a sixth flag corresponding to each filter bank, the sixth flag being configured for indicating whether a current filter bank is the second target filter bank.

A specific implementation of S1130 is the same as that of S720. Details are not described herein again.
S1140: Obtain, if a value of the sixth flag is a first value, a third nonlinear clipping index, the third nonlinear clipping index being the nonlinear clipping index shared by the tap coefficients of the filters in the second target filter bank.

A specific implementation of S1140 is the same as that of S730. Details are not described herein again.

In the solution provided in Embodiment 11, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 12

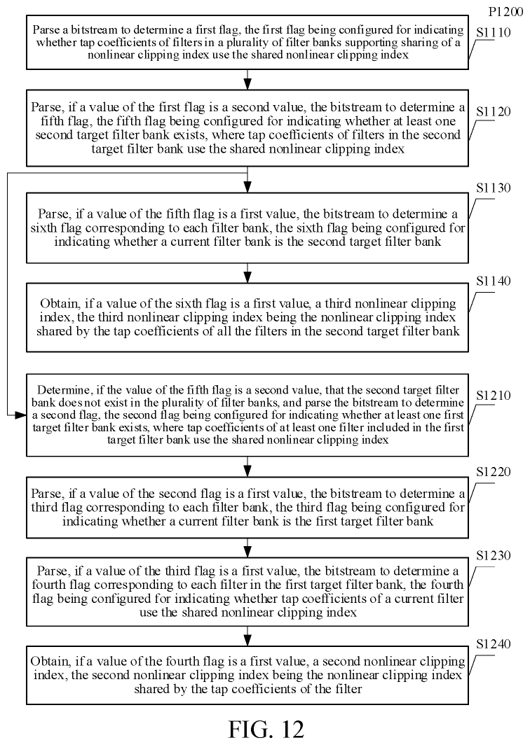

Based on Embodiment 1, Embodiment 12 of the present disclosure also provides a decoding method P1200. All implementations recorded in Embodiment 1 may be applied to Embodiment 12, and can achieve the same technical effect. FIG. 12 is a schematic flowchart of a decoding method P1200 according to some embodiments of the present disclosure. In the some embodiments, operations illustrated in FIG. 12 may be performed sequentially, in a different order, in parallel, or with some operations skipped or repeated. Referring to FIG. 12, the method P1200 is implemented based on the method P1100. The method P1200 includes S1110 to S1140 and S1210 to S1240.

As a specific implementation of S410, S1110 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1120 to S1140 and S1210 to S1240 are performed.

Specific implementations of S1110 to S1140 are described in detail in the foregoing embodiments. Details are not described herein again.
S1210: Determine, if the value of the fifth flag is a second value, that the second target filter bank does not exist in the plurality of filter banks, and parse the bitstream to determine a second flag, the second flag being configured for indicating whether at least one first target filter bank exists, where tap coefficients of at least one filter included in the first target filter bank use the shared nonlinear clipping index.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. To be specific, the second target filter bank does not exist. Then, the electronic device parses the bitstream to determine whether a first target filter bank exists in all the supported filter banks.

By way of example, the electronic device parses the bitstream to determine a value of a second flag. The second flag is configured for indicating whether at least one first target filter bank exists, where tap coefficients of at least one filter included in the first target filter bank use the shared nonlinear clipping index. By way of example, at a coder side, whether the first target filter bank exists in the plurality of filter banks may be determined by using an RDO cost. When determining that the first target filter bank exists in the plurality of filter banks supporting sharing of the nonlinear clipping index, the coder determines a value of a second flag and writes the second flag and the value thereof into the bitstream. Therefore, the electronic device may obtain the value of the second flag by parsing the bitstream.

By way of example, the second flag may be represented as “alf_alt_has_filter_share_nonlinear”. If a value of alf_alt_has_filter_share_nonlinear is a second value (e.g., “0”), it indicates that none of a plurality of filter banks supporting sharing of a nonlinear clipping index shares the nonlinear clipping index. If the value of alf_alt_has_filter_share_nonlinear is a first value (e.g., “1”), it indicates that the at least one first target filter bank exists in the plurality of filter banks.
S1220: Parse, if a value of the second flag is a first value, the bitstream to determine a third flag corresponding to each filter bank, the third flag being configured for indicating whether a current filter bank is the first target filter bank.

A specific implementation of S1220 is the same as that of S520. Details are not described herein again.
S1230: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

A specific implementation of S1230 is the same as that of S530. Details are not described herein again.
S1240: Obtain, if a value of the fourth flag is a first value, a second nonlinear clipping index, the second nonlinear clipping index being the nonlinear clipping index shared by the tap coefficients of the filter.

A specific implementation of S1240 is the same as that of S540. Details are not described herein again.

In the solution provided in Embodiment 12, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 13

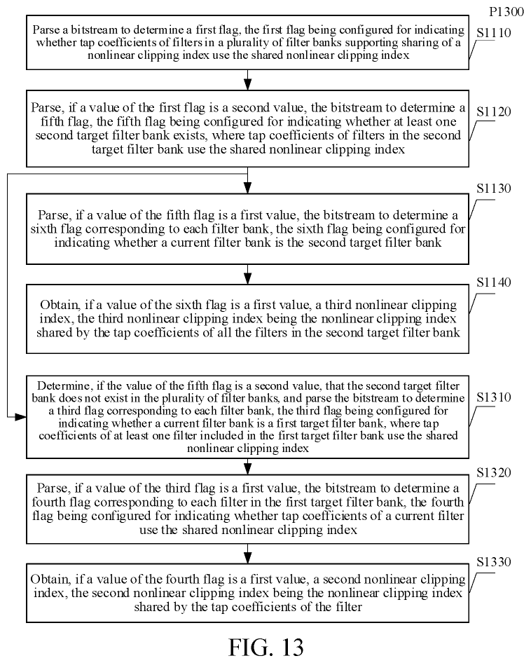

Based on Embodiment 1, Embodiment 13 of the present disclosure also provides a decoding method P1300. All implementations recorded in Embodiment 1 may be applied to Embodiment 13, and can achieve the same technical effect. FIG. 13 is a schematic flowchart of a decoding method P1300 according to some embodiments of the present disclosure. In the some embodiments, operations illustrated in FIG. 13 may be performed sequentially, in a different order, in parallel, or with some operations skipped or repeated. Referring to FIG. 13, the method P1300 is implemented based on the method P1100. The method P1300 includes S1110 to S1140 and S1310 to S1330.

As a specific implementation of S410, S1110 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1120 to S1140 and S1310 to S1330 are performed.

Specific implementations of S1110 to S1140 are described in detail in the foregoing embodiments. Details are not described herein again.
S1310: Determine, if the value of the fifth flag is a second value, that the second target filter bank does not exist in the plurality of filter banks, and parse the bitstream to determine a third flag corresponding to each filter bank, the third flag being configured for indicating whether a current filter bank is a first target filter bank, where tap coefficients of at least one filter included in the first target filter bank use the shared nonlinear clipping index.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. To be specific, the second target filter bank does not exist.

To determine, in all supported filter banks, which filter bank belongs to the first target filter bank, the electronic device needs to determine a third flag corresponding to an i^{th} (i is an integer having a value of 1 to Y in sequence) filter bank among all the supported filter banks (assuming that Y filter banks are included). The third flag of the i^{th} filter bank is configured for indicating whether the i^{th} filter bank is the first target filter bank. To be specific, tap coefficients of at least one filter included in the i^{th} filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S1320: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

A specific implementation of S1320 is the same as that of S530. Details are not described herein again.
S1330: Obtain, if a value of the fourth flag is a first value, a second nonlinear clipping index, the second nonlinear clipping index being the nonlinear clipping index shared by the tap coefficients of the filter.

A specific implementation of S1330 is the same as that of S540. Details are not described herein again.

In the solution provided in Embodiment 13, for the plurality of respective tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 14

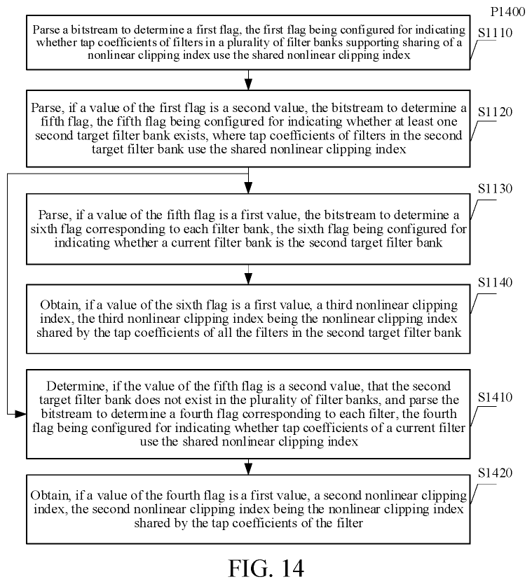

Based on Embodiment 1, Embodiment 14 of the present disclosure also provides a decoding method P1400. All implementations recorded in Embodiment 1 may be applied to Embodiment 14, and can achieve the same technical effect. FIG. 14 is a schematic flowchart of a decoding method P1400 according to some embodiments of the present disclosure. In the some embodiments, operations illustrated in FIG. 14 may be performed sequentially, in a different order, in parallel, or with some operations skipped or repeated. Referring to FIG. 14, the method P1400 is implemented based on the method P1100. The method P1400 includes S1110 to S1140 and S1410 to S1420.

As a specific implementation of S410, S1110 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1120 to S1140 and S1410 to S1420 are performed.

Specific implementations of S1110 to S1140 are described in detail in the foregoing embodiments. Details are not described herein again.
S1410: Determine, if the value of the fifth flag is a second value, that the second target filter bank does not exist in the plurality of filter banks, and parse the bitstream to determine a fourth flag corresponding to each filter, the fourth flag being configured for indicating whether tap coefficients of a current filter use the shared nonlinear clipping index. By way of example, the fifth flag may be represented as

“alf_has_filterset_share_nonlinear”. If a value of alf_has_filterset_share_nonlinear is a second value (e.g., “0”), it indicates that none of filters in all supported filter banks uses the shared nonlinear clipping index. To be specific, the second target filter bank does not exist.

To determine, from all supported filter banks, which filter in the first target filter bank has tap coefficients sharing the nonlinear clipping index, a value of a fourth flag corresponding to each filter in all the supported filter banks needs to be determined. Assuming that all the supported filter banks include X filters, a fourth flag of a j^{th} filter (j is an integer having a value of 1 to X in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S1420: Obtain, if a value of the fourth flag is a first value, a second nonlinear clipping index, the second nonlinear clipping index being the nonlinear clipping index shared by the tap coefficients of the filter.

A specific implementation of S1420 is the same as that of S540. Details are not described herein again.

In the solution provided in Embodiment 14, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 15

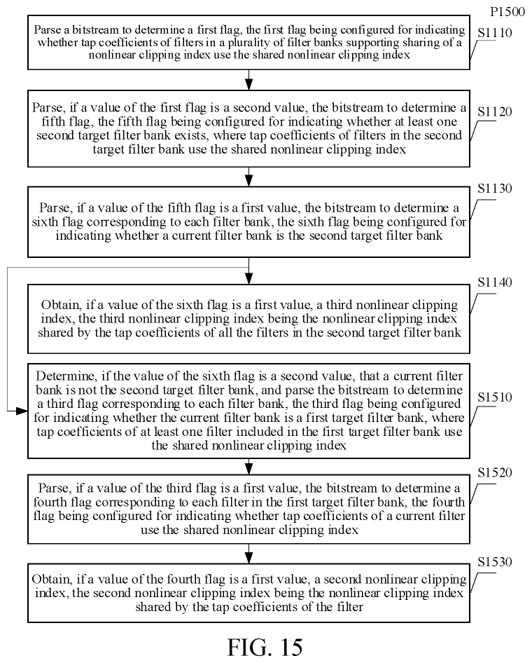

Based on Embodiment 1, Embodiment 15 of the present disclosure also provides a decoding method P1500. All implementations recorded in Embodiment 1 may be applied to Embodiment 15, and can achieve the same technical effect. FIG. 15 is a schematic flowchart of a decoding method P1500 according to some embodiments of the present disclosure. In the some embodiments, operations illustrated in FIG. 15 may be performed sequentially, in a different order, in parallel, or with some operations skipped or repeated. Referring to FIG. 15, the method P1500 is implemented based on the method P1100. The method P1500 includes S1110 to S1140 and S1510 to S1530.

As a specific implementation of S410, S1110 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1120 to S1140 and S1510 to S1530 are performed.

Specific implementations of S1110 to S1140 are described in detail in the foregoing embodiments. Details are not described herein again.
S1510: Determine, if the value of the sixth flag is a second value, that a current filter bank is not the second target filter bank, and parse the bitstream to determine a third flag corresponding to each filter bank, the third flag being configured for indicating whether the current filter bank is a first target filter bank, where tap coefficients of at least one filter included in the first target filter bank use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine whether the current filter bank belongs to the first target filter bank, the electronic device performs decoding to determine a third flag corresponding to the current filter bank. The third flag of the current filter bank is configured for indicating whether the current filter bank is the first target filter bank. To be specific, tap coefficients of at least one filter included in the current filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S1520: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

A specific implementation of S1520 is the same as that of S530. Details are not described herein again.
S1530: Obtain, if a value of the fourth flag is a first value, a second nonlinear clipping index, the second nonlinear clipping index being the nonlinear clipping index shared by the tap coefficients of the filter.

A specific implementation of S1530 is the same as that of S540. Details are not described herein again.

In the solution provided in Embodiment 15, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 16

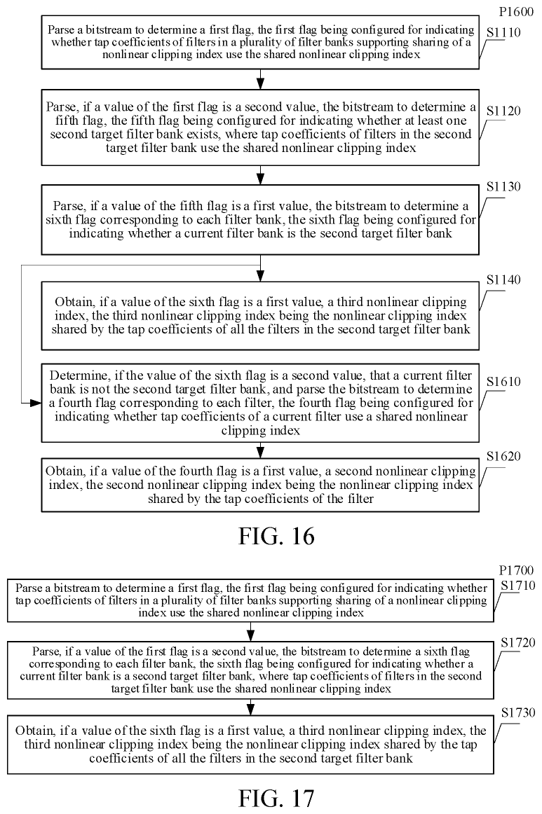

Based on Embodiment 1, Embodiment 16 of the present disclosure also provides a decoding method P1600. All implementations recorded in Embodiment 1 may be applied to Embodiment 16, and can achieve the same technical effect. FIG. 16 is a schematic flowchart of a decoding method P1600 according to some embodiments of the present disclosure. In the some embodiments, operations illustrated in FIG. 16 may be performed sequentially, in a different order, in parallel, or with some operations skipped or repeated. Referring to FIG. 16, the method P1600 is implemented based on the method P1100. The method P1600 includes S1110 to S1140 and S1610 to S1620.

As a specific implementation of S410, S1110 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1120 to S1140 and S1610 to S1620 are performed.

Specific implementations of S1110 to S1140 are described in detail in the foregoing embodiments. Details are not described herein again.
S1610: Determine, if the value of the sixth flag is a second value, that a current filter bank is not the second target filter bank, and parse the bitstream to determine a fourth flag corresponding to each filter, the fourth flag being configured for indicating whether tap coefficients of a current filter use a shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine, from a current filter bank, which filter in the first target filter bank has tap coefficients sharing the nonlinear clipping index, a value of a fourth flag corresponding to each filter in the current filter bank needs to be determined. Assuming that the current filter bank includes Z filters, a fourth flag of a j^{th} filter (j is an integer having a value of 1 to Z in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S1620: Obtain, if a value of the fourth flag is a first value, a second nonlinear clipping index, the second nonlinear clipping index being the nonlinear clipping index shared by the tap coefficients of the filter.

A specific implementation of S1620 is the same as that of S540. Details are not described herein again.

In the solution provided in Embodiment 16, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 17

Based on Embodiment 1, Embodiment 17 of the present disclosure also provides a decoding method P1700. All implementations recorded in Embodiment 1 may be applied to Embodiment 17, and can achieve the same technical effect. FIG. 17 is a schematic flowchart of a decoding method P1700 according to some embodiments of the present disclosure. In the some embodiments, operations illustrated in FIG. 17 may be performed sequentially, in a different order, in parallel, or with some operations skipped or repeated. Referring to FIG. 17, the method P1700 includes S1710 to S1730.

As a specific implementation of S410, S1710 includes: parsing a bitstream to determine a first flag, the first flag being configured for indicating whether tap coefficients of filters in a plurality of filter banks supporting sharing of a nonlinear clipping index use the shared nonlinear clipping index.

A specific implementation of S1710 is the same as that of S810. Details are not described herein again.

As a specific implementation of S420, S1720 to S1730 are performed.
S1720: Parse, if a value of the first flag is a second value, the bitstream to determine a sixth flag corresponding to each filter bank, the sixth flag being configured for indicating whether a current filter bank is a second target filter bank, where tap coefficients of filters in the second target filter bank use the shared nonlinear clipping index.

If the value of the first flag alf_alt_share_nonlinear_flag is a second value (e.g., “0”), it indicates that the shared nonlinear clipping index is not used for tap coefficients of all filters in a plurality of supportable filter banks. The electronic device needs to parse the bitstream to determine whether a second target filter bank exists, where tap coefficients of filters in the second target filter bank use the shared nonlinear clipping index.

To further determine which filter bank belongs to the second target filter bank, the electronic device parses the bitstream to determine a value of a sixth flag corresponding to each filter bank. By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index. If the value of alf_filterset_share_nonlinear_flag is a first value (e.g., “1”), it indicates that the current filter bank belongs to the second target filter bank. To be specific, tap coefficients of all filters in the current filter bank use the shared nonlinear clipping index.
S1730: Obtain, if a value of the sixth flag is a first value, a third nonlinear clipping index, the third nonlinear clipping index being the nonlinear clipping index shared by the tap coefficients of the filters in the second target filter bank.

A specific implementation of S1730 is the same as that of S730. Details are not described herein again.

In the solution provided in Embodiment 17, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 18

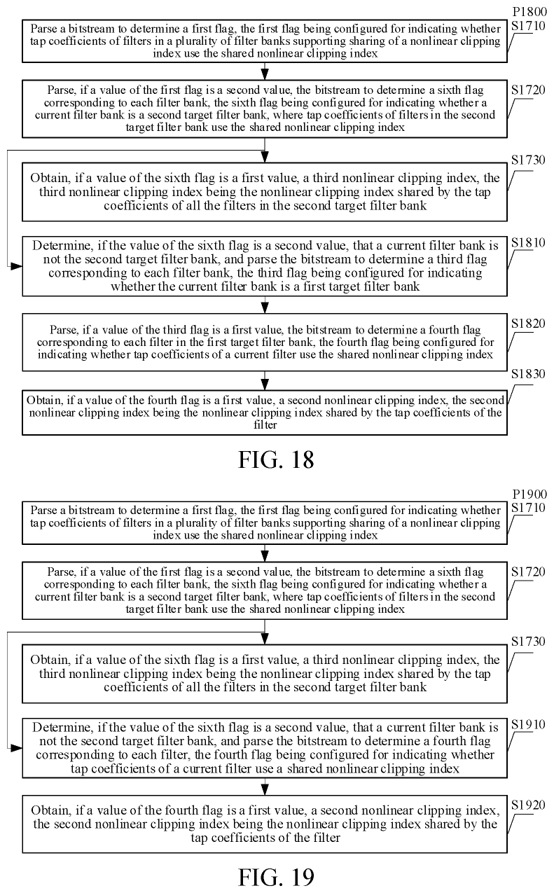

Based on Embodiment 1, Embodiment 18 of the present disclosure also provides a decoding method P1800. All implementations recorded in Embodiment 1 may be applied to Embodiment 18, and can achieve the same technical effect. FIG. 18 is a schematic flowchart of a decoding method P1800 according to some embodiments of the present disclosure. In the some embodiments, operations illustrated in FIG. 18 may be performed sequentially, in a different order, in parallel, or with some operations skipped or repeated. Referring to FIG. 18, the method P1800 is implemented based on the method P1700. The method P1800 includes S1710 to S1730 and S1810 to S1830.

As a specific implementation of S410, S1710 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1720 to S1730 and S1810 to S1830 are performed.

Specific implementations of S1710 to S1730 are described in detail in the foregoing embodiments. Details are not described herein again.
S1810: Determine, if the value of the sixth flag is a second value, that a current filter bank is not the second target filter bank, and parse the bitstream to determine a third flag corresponding to each filter bank, the third flag being configured for indicating whether the current filter bank is a first target filter bank, where tap coefficients of at least one filter included in the first target filter bank use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine whether the current filter bank belongs to the first target filter bank, the electronic device performs decoding to determine a third flag corresponding to the current filter bank. The third flag of the current filter bank is configured for indicating whether the current filter bank is the first target filter bank. To be specific, tap coefficients of at least one filter included in the current filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S1820: Parse, if a value of the third flag is a first value, the bitstream to determine a fourth flag corresponding to each filter in the first target filter bank, the fourth flag being configured for indicating whether tap coefficients of a current filter use the shared nonlinear clipping index.

A specific implementation of S1820 is the same as that of S530. Details are not described herein again.
S1830: Obtain, if a value of the fourth flag is a first value, a second nonlinear clipping index, the second nonlinear clipping index being the nonlinear clipping index shared by the tap coefficients of the filter.

A specific implementation of S1530 is the same as that of S540. Details are not described herein again.

In the solution provided in Embodiment 18, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 19

Based on Embodiment 1, Embodiment 19 of the present disclosure also provides a decoding method P1900. All implementations recorded in Embodiment 1 may be applied to Embodiment 19, and can achieve the same technical effect. FIG. 19 is a schematic flowchart of a decoding method P1900 according to some embodiments of the present disclosure. In the some embodiments, operations illustrated in FIG. 19 may be performed sequentially, in a different order, in parallel, or with some operations skipped or repeated. Referring to FIG. 19, the method P1900 is implemented based on the method P1700. The method P1900 includes S1710 to S1730 and S1910 to S1920.

As a specific implementation of S410, S1710 includes: parsing a bitstream to determine a first flag, the first flag being configured for indicating whether tap coefficients of filters in a plurality of filter banks supporting sharing of a nonlinear clipping index use the shared nonlinear clipping index.

As a specific implementation of S420, S1720 to S1730 and S1910 to S1920 are performed.
S1910: Determine, if the value of the sixth flag is a second value, that a current filter bank is not the second target filter bank, and parse the bitstream to determine a fourth flag corresponding to each filter, the fourth flag being configured for indicating whether tap coefficients of a current filter use a shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine, from a current filter bank, which filter in the first target filter bank has tap coefficients sharing the nonlinear clipping index, a value of a fourth flag corresponding to each filter in the current filter bank needs to be determined. Assuming that the current filter bank includes Z filters, a fourth flag of a j^{th} filter (j is an integer having a value of 1 to Z in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S1920: Obtain, if a value of the fourth flag is a first value, a second nonlinear clipping index, the second nonlinear clipping index being the nonlinear clipping index shared by the tap coefficients of the filter.

A specific implementation of S1920 is the same as that of S540. Details are not described herein again.

In the solution provided in Embodiment 19, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

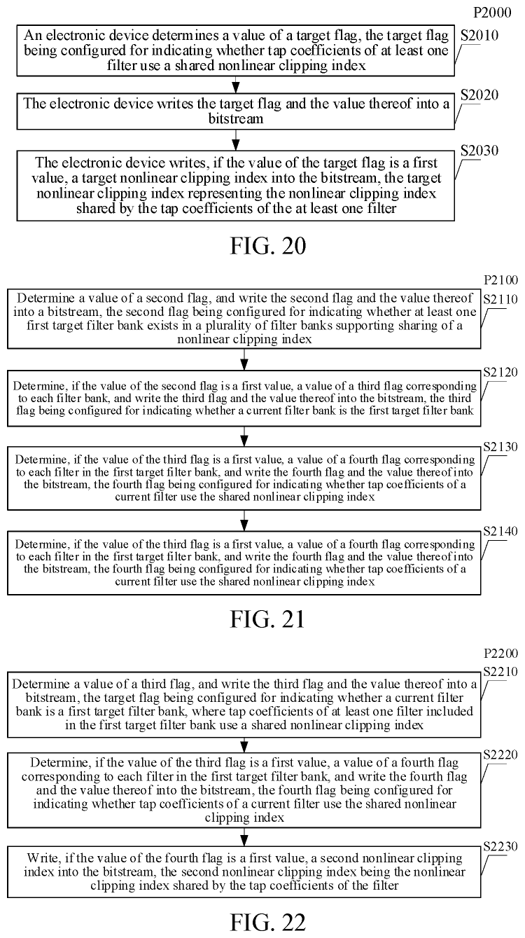

The decoding method embodiments of the present disclosure are described in detail above with reference to FIG. 4 to FIG. 19. Some embodiments of a video coding method of the present disclosure are described below with reference to FIG. 20 to FIG. 35.

### Embodiment 20

FIG. 20 is a schematic flowchart of a coding method P2000 according to some embodiments of the present disclosure. The coding method P2000 is performed by an electronic device. In the some embodiments, operations illustrated in FIG. 20 may be performed sequentially, in a different order, in parallel, or with some operations skipped or repeated. For example, the electronic device may be configured to execute a video coding task, and may be exemplarily recorded as a coder, a coding device, or the like. Referring to FIG. 20, the method P2000 includes:
S2010: An electronic device determines a value of a target flag, the target flag being configured for indicating whether tap coefficients of at least one filter use a shared nonlinear clipping index.

By way of example, a coder may determine, according to an RDO cost, whether tap coefficients of a filter use a shared nonlinear clipping index. It is determined that the value of the target flag is a first value (e.g., “1”) if tap coefficients of at least one filter use the shared nonlinear clipping index. It is determined that the value of the target flag is not the first value, for example, the value is a second value (e.g., “0”) if there is no filter having tap coefficients using the shared nonlinear clipping index.
S2020: The electronic device writes the target flag and the value thereof into a bitstream.
S2030: The electronic device writes, if the value of the target flag is a first value, a target nonlinear clipping index into the bitstream, the target nonlinear clipping index being the nonlinear clipping index shared by the tap coefficients of the at least one filter.

When the value of the target flag is the first value, the coder writes the target nonlinear clipping index into the bitstream. Therefore, the electronic device may parse the bitstream to obtain the target nonlinear clipping index, so that the target nonlinear clipping index serves as the nonlinear clipping index shared by the tap coefficients of the at least one filter.

By way of example, a preset mapping relationship exists between different nonlinear clipping indexes and different nonlinear clipping intervals. For example, four clipping indexes [0, 1, 2, 3] similar to a VTM or an ECM may be used, and absolute values of clipping intervals of the index association relationship are respectively [1024, 128, 32, 8]. To improve the fine degree, a quantity of clipping indexes may be increased according to an actual requirement. For example, eight clipping indexes [0, 1, 2, 3, 4, 5, 6, 7] are used, and absolute values of clipping intervals of the index association relationship may be [1024, 256, 128, 64, 32, 16, 8, 4].

By way of example, the coder writes the target clipping index and a corresponding target clipping interval into the bitstream. Therefore, after parsing the bitstream to determine the target nonlinear clipping index, the electronic device obtains a target nonlinear clipping interval having a mapping relationship with the target nonlinear clipping index, to perform a nonlinear clipping operation on an input of the at least one filter by using the target nonlinear clipping interval. Therefore, a difference between an input of ALF and a current pixel is limited by means of clipping. Further, ALF can consider a spatial similarity and a sample similarity between adjacent pixels and a current to-be-processed pixel. Some embodiments of the present disclosure provide an enhanced ALF nonlinear clipping method, which can improve performance of the ALF nonlinear clipping.

By way of example, the nonlinear clipping index and the corresponding clipping interval may be transmitted in an HLS (a sequence parameter set (SPS), a picture parameter set (PPS), a video parameter set (VPS), an APS, a PictureHeader, a SliceHeader, or the like).

By way of example, whether to use the target nonlinear index for sharing provided in some embodiments of the present disclosure may be transmitted in the HLS (the SPS, the PPS, the VPS, the APS, the PictureHeader, the SliceHeader, or the like).

In the solution provided by the method P2000 in the present disclosure, the coder determines a value of a target flag, and writes into the bitstream. If the value of the target flag is a first value, it indicates that there is at least one filter having tap coefficients using a shared nonlinear clipping index. If the value of the target flag is not the first value, it indicates that there is no filter having tap coefficients using the shared nonlinear clipping index. Further, in a case that the value of the target flag is the first value, the coder writes a target nonlinear clipping index into the bitstream. The target nonlinear clipping index is the nonlinear clipping index shared by the tap coefficients of the at least one filter. In some embodiments of the present disclosure, nonlinear clipping indexes respectively corresponding to a plurality of tap coefficients of the at least one filter may be represented by one target nonlinear clipping index. For the same quantity of tap coefficients, a quantity of nonlinear clipping indexes can be reduced, so that bit overheads of the nonlinear clipping indexes can be effectively reduced, thereby facilitating improving video compression efficiency. For example, some embodiments of the present disclosure provide an enhanced ALF nonlinear clipping method, which can improve performance of the ALF nonlinear clipping.

### Embodiment 21

Based on Embodiment 20, Embodiment 21 of the present disclosure also provides a coding method. All implementations recorded in Embodiment 20 may be applied to Embodiment 21, and can achieve the same technical effect.

In some embodiments of the present disclosure, the target flag includes a first flag, the first flag being configured for indicating whether tap coefficients of all filters in a plurality of filter banks supporting sharing of a nonlinear clipping index use the shared nonlinear clipping index. By way of example, at a coder side, whether to use the shared nonlinear clipping index for the tap coefficients of all the filters in the plurality of supportable filter banks may be determined by using an RDO cost. When determining that the plurality of filter banks support tap coefficients of all filters to use the shared nonlinear clipping index, the coder determines a value of a first flag and writes the first flag and the value thereof into the bitstream. Therefore, the electronic device may obtain the value of the first flag by parsing the bitstream.

By way of example, the first flag may be represented as “alf_alt_share_nonlinear_flag”. If a value of alf_alt_share_nonlinear_flag is a second value (e.g., “0”), it indicates that the shared nonlinear clipping index is not used for the tap coefficients of all the filters in the plurality of filter banks. If the value of alf_alt_share_nonlinear_flag is a first value (e.g., “1”), it indicates that the shared nonlinear clipping index is used for the tap coefficients of all the filters in the plurality of filter banks.

When the value of the first flag alf_alt_share_nonlinear_flag is a first value (e.g., “1”), the electronic device may parse the bitstream, to determine a first nonlinear clipping index, which is exemplarily represented as “alf_alt_shared_nonlinear_idx”. Therefore, the first nonlinear clipping index “alf_alt_shared_nonlinear_idx” may represent the nonlinear clipping index shared by the tap coefficients of all the filters in the plurality of filter banks.

In this exemplary embodiment, a transmission process of related syntax elements “alf_alt_share_nonlinear_flag” and “alf_alt_shared_nonlinear_idx” is shown in Table 4.

In the solution provided in Embodiment 21, for the plurality of filter banks, only one shared nonlinear clipping index needs to be transmitted, to implement a nonlinear clipping operation on inputs of all the filters in the plurality of filter banks. Therefore, bit overheads of the nonlinear clipping indexes can be significantly reduced, thereby facilitating improving video compression efficiency.

### Embodiment 22

Based on Embodiment 20, Embodiment 22 of the present disclosure also provides a coding method P2100. All implementations recorded in Embodiment 20 may be applied to Embodiment 22, and can achieve the same technical effect. FIG. 21 is a schematic flowchart of a coding method P2100 according to some embodiments of the present disclosure. In the some embodiments, operations illustrated in FIG. 21 may be performed sequentially, in a different order, in parallel, or with some operations skipped or repeated.
S2110: Determine a value of a second flag, and write the second flag and the value thereof into a bitstream, the second flag being configured for indicating whether at least one first target filter bank exists in a plurality of filter banks supporting sharing of a nonlinear clipping index, where tap coefficients of at least one filter included in the first target filter bank use the shared nonlinear clipping index.

In this embodiment, the target flag includes a second flag, the second flag being configured for indicating whether at least one first target filter bank exists in a plurality of filter banks supporting sharing of a nonlinear clipping index, where tap coefficients of at least one filter included in the first target filter bank use the shared nonlinear clipping index. By way of example, at a coder side, whether the first target filter bank exists in the plurality of filter banks may be determined by using an RDO cost. When determining that the first target filter bank exists in the plurality of filter banks supporting sharing of the nonlinear clipping index, the coder determines a value of a second flag and writes the second flag and the value thereof into the bitstream. Therefore, the electronic device may obtain the value of the second flag by parsing the bitstream.

By way of example, the second flag may be represented as “alf_alt_has_filter_share_nonlinear”. If a value of alf_alt_has_filter_share_nonlinear is a second value (e.g., “0”), it indicates that none of a plurality of filter banks supporting sharing of a nonlinear clipping index shares the nonlinear clipping index. If the value of alf_alt_has_filter_share_nonlinear is a first value (e.g., “1”), it indicates that the at least one first target filter bank exists in the plurality of filter banks.
S2120: Determine, if the value of the second flag is a first value, a value of a third flag corresponding to each filter bank, and write the third flag and the value thereof into the bitstream, the third flag being configured for indicating whether a current filter bank is the first target filter bank.

As described above, if the value of the second flag alf_alt_has_filter_share_nonlinear is a first value (e.g., “1”), it indicates that the at least one first target filter bank exists in the plurality of (e.g., N) filter banks. Further, to further determine which filter bank belongs to the first target filter bank, the electronic device needs to determine a third flag corresponding to an i^{th} (i is an integer having a value of 1 to N in sequence) filter bank among the N filter banks. The third flag of the i^{th} filter bank is configured for indicating whether the i^{th} filter bank is the first target filter bank. To be specific, tap coefficients of at least one filter included in the i^{th} filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S2130: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

As described above, if the value of the third flag alf_filterset_has_filter_share_nonlinear is a first value (e.g., “1”), it indicates that a current filter bank belongs to the first target filter bank. To be specific, tap coefficients of at least one filter included in the current filter bank use the shared nonlinear clipping index. Further, to further determine which filter in the first target filter bank has tap coefficients sharing the nonlinear clipping index, a value of a fourth flag corresponding to each filter in the first target filter bank needs to be determined. Assuming that the first target filter bank currently includes M filters, a fourth flag of a j^{th} filter (j is an integer having a value of 1 to M in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “O”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S2140: Write, if the value of the fourth flag is a first value, a second nonlinear clipping index into the bitstream, the second nonlinear clipping index being the nonlinear clipping index shared by the tap coefficients of the filter.

As described above, if the value of the fourth flag alf_filter_share_nonlinear is a first value (e.g., “1”), it indicates that tap coefficients of a current filter use the shared nonlinear clipping index. To be specific, a filter having tap coefficient using the shared nonlinear clipping index is determined. Further, the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the determined filter.

In this exemplary embodiment, a transmission process of related syntax elements is shown in Table 5.

In the solution provided in Embodiment 22, for the plurality of tap coefficients of the determined filter, only one shared nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 23

Based on Embodiment 20, Embodiment 23 of the present disclosure also provides a coding method P2200. All implementations recorded in Embodiment 20 may be applied to Embodiment 23, and can achieve the same technical effect. FIG. 22 is a schematic flowchart of a coding method P2200 according to some embodiments of the present disclosure. In the some embodiments, operations illustrated in FIG. 22 may be performed sequentially, in a different order, in parallel, or with some operations skipped or repeated
S2210: Determine a value of a third flag, and write the third flag and the value thereof into a bitstream, the target flag being configured for indicating whether a current filter bank is a first target filter bank, where tap coefficients of at least one filter included in the first target filter bank use a shared nonlinear clipping index.

In this embodiment, the target flag includes a third flag, the third flag being configured for indicating whether a current filter bank is a first target filter bank, where tap coefficients of at least one filter included in the first target filter bank use the shared nonlinear clipping index. By way of example, at a coder side, whether a current filter bank belongs to the first target filter bank may be determined by using an RDO cost. When determining that the first target filter bank exists in the current filter bank, the coder determines a value of a third flag and writes the third flag and the value thereof into the bitstream. Therefore, the electronic device may obtain the value of the third flag by parsing the bitstream.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S2220: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

As described above, if the value of the third flag alf_filterset_has_filter_share_nonlinear is a first value (e.g., “1”), it indicates that a current filter bank belongs to the first target filter bank. To be specific, tap coefficients of at least one filter included in the current filter bank use the shared nonlinear clipping index. Further, to further determine which filter in the first target filter bank has tap coefficients sharing the nonlinear clipping index, a value of a fourth flag corresponding to each filter in the first target filter bank needs to be determined. Assuming that the first target filter bank currently includes M filters, a fourth flag of a j^{th} filter (j is an integer having a value of 1 to M in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “O”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S2230: Write, if the value of the fourth flag is a first value, a second nonlinear clipping index into the bitstream, the second nonlinear clipping index being the nonlinear clipping index shared by the tap coefficients of the filter.

As described above, if the value of the fourth flag alf_filter_share_nonlinear is a first value (e.g., “1”), it indicates that tap coefficients of a current filter use the shared nonlinear clipping index. To be specific, a filter having tap coefficient using the shared nonlinear clipping index is determined. Further, the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the determined filter.

In this exemplary embodiment, a transmission process of related syntax elements is shown in Table 6.

In the solution provided in Embodiment 23, for the plurality of tap coefficients of the determined filter, only one shared nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 24

Based on Embodiment 20, Embodiment 24 of the present disclosure also provides a coding method. All implementations recorded in Embodiment 20 may be applied to Embodiment 24, and can achieve the same technical effect.

The target flag includes a fourth flag, the fourth flag being configured for indicating whether tap coefficients of a current filter use the shared nonlinear clipping index. By way of example, at a coder side, whether to use the shared nonlinear clipping index for tap coefficients of a current filter may be determined by using an RDO cost. When determining that the tap coefficients of the current filter use the shared nonlinear clipping index, the coder determines a value of a fourth flag and writes the fourth flag and the value thereof into the bitstream. Therefore, the electronic device may obtain the value of the fourth flag by parsing the bitstream.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.

When the value of the fourth flag alf_filter_share_nonlinear is a first value (e.g., “1”), the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the current filter.

In this exemplary embodiment, a transmission process of related syntax elements is shown in Table 7.

In the solution provided in Embodiment 24, for the plurality of tap coefficients of the filter, only one shared nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 25

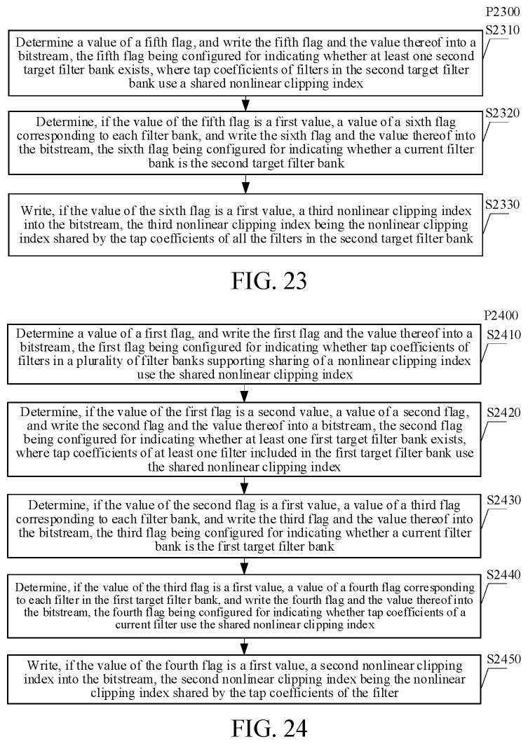

Based on Embodiment 20, Embodiment 25 of the present disclosure also provides a coding method P2300. All implementations recorded in Embodiment 20 may be applied to Embodiment 25, and can achieve the same technical effect. FIG. 23 is a schematic flowchart of a coding method P2300 according to some embodiments of the present disclosure. In the some embodiments, operations illustrated in FIG. 23 may be performed sequentially, in a different order, in parallel, or with some operations skipped or repeated.
S2310: Determine a value of a fifth flag, and write the fifth flag and the value thereof into a bitstream, the fifth flag being configured for indicating whether at least one second target filter bank exists, where tap coefficients of filters in the second target filter bank use a shared nonlinear clipping index.

In this embodiment, the target flag includes a fifth flag, the fifth flag being configured for indicating whether at least one second target filter bank exists in a plurality of filter banks supporting sharing of a nonlinear clipping index, where tap coefficients of filters in the second target filter bank use the shared nonlinear clipping index. By way of example, at a coder side, whether the second target filter bank exists in the plurality of filter banks may be determined by using an RDO cost. When determining that the second target filter bank exists in the plurality of filter banks supporting sharing of the nonlinear clipping index, the coder determines a value of a fifth flag and writes the fifth flag and the value thereof into the bitstream. Therefore, the electronic device may obtain the value of the fifth flag by parsing the bitstream.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. No additional syntax elements related to the shared nonlinear index need to be transmitted. If the value of alf_has_filterset_share_nonlinear is a first value (e.g., “1”), it indicates that the at least one second target filter bank exists in the plurality of filter banks.
S2320: Determine, if the value of the fifth flag is a first value, a value of a sixth flag corresponding to each filter bank, and write the sixth flag and the value thereof into the bitstream, the sixth flag being configured for indicating whether a current filter bank is the second target filter bank.

As described above, if the value of the fifth flag alf_has_filterset_share_nonlinear is a first value (e.g., “1”), it indicates that the at least one second target filter bank exists in the plurality of (e.g., L) filter banks. Further, to further determine which filter bank belongs to the second target filter bank, it is necessary to determine a sixth flag corresponding to an i^{th} (i is an integer having a value of 1 to L in sequence) filter bank among the L filter banks. The sixth flag of the i^{th} filter bank is configured for indicating whether the i^{th} filter bank is the second target filter bank. To be specific, tap coefficients of all filters in the i^{th} filter bank use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index. If the value of alf_filterset_share_nonlinear_flag is a first value (e.g., “1”), it indicates that the current filter bank belongs to the second target filter bank. To be specific, tap coefficients of all filters in the current filter bank use the shared nonlinear clipping index.
S2330: Write, if the value of the sixth flag is a first value, a third nonlinear clipping index into the bitstream, the third nonlinear clipping index being the nonlinear clipping index shared by the tap coefficients of the filters in the second target filter bank.

As described above, if the value of the sixth flag alf_filterset_share_nonlinear_flag is a first value (e.g., “1”), it indicates that tap coefficients of all filters in a current filter bank use the shared nonlinear clipping index. To be specific, a filter having tap coefficient using the shared nonlinear clipping index is determined. Further, the electronic device may parse the bitstream, to determine a third nonlinear clipping index, which is exemplarily represented as “alf_filterset_shared_nonlinear_idx”. Therefore, the third nonlinear clipping index “alf_filterset_shared_nonlinear_idx” may represent the nonlinear clipping index shared by the tap coefficients of the determined filter.

In this exemplary embodiment, a transmission process of related syntax elements is shown in Table 8.

In the solution provided in Embodiment 25, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 26

Based on Embodiment 20, Embodiment 26 of the present disclosure also provides a coding method. All implementations recorded in Embodiment 20 may be applied to Embodiment 26, and can achieve the same technical effect.

The target flag includes a sixth flag, the sixth flag being configured for indicating whether a current filter bank is a second target filter bank, where tap coefficients of filters in the second target filter bank use the shared nonlinear clipping index. By way of example, at a coder side, whether to use the shared nonlinear clipping index for tap coefficients of all filters in a current filter bank may be determined by using an RDO cost. When determining that the tap coefficients of all the filters in the current filter bank use the shared nonlinear clipping index, the coder determines a value of a sixth flag and writes the sixth flag and the value thereof into the bitstream. Therefore, the electronic device may obtain the value of the sixth flag by parsing the bitstream.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index. If the value of alf_filterset_share_nonlinear_flag is a first value (e.g., “1”), it indicates that the current filter bank belongs to the second target filter bank. To be specific, tap coefficients of all filters in the current filter bank use the shared nonlinear clipping index.

When the value of the sixth flag alf_filterset_share_nonlinear_flag is a first value (e.g., “1”), the electronic device may parse the bitstream, to determine a third nonlinear clipping index, which is exemplarily represented as “alf_filterset_shared_nonlinear_idx”. Therefore, the third nonlinear clipping index “alf_filterset_shared_nonlinear_idx” may represent the nonlinear clipping index shared by the tap coefficients of all the filters in the current filter bank.

In this exemplary embodiment, a transmission process of related syntax elements is shown in Table 9.

In the solution provided in Embodiment 26, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 27

Based on Embodiment 20, Embodiment 27 of the present disclosure also provides a coding method P2400. All implementations recorded in Embodiment 20 may be applied to Embodiment 27, and can achieve the same technical effect. FIG. 24 is a schematic flowchart of a coding method P2400 according to some embodiments of the present disclosure. In the some embodiments, operations illustrated in FIG. 24 may be performed sequentially, in a different order, in parallel, or with some operations skipped or repeated.
S2410: Determine a value of a first flag, and write the first flag and the value thereof into a bitstream, the first flag being configured for indicating whether tap coefficients of all filters in a plurality of filter banks supporting sharing of a nonlinear clipping index use the shared nonlinear clipping index.

The target flag includes a first flag, the first flag being configured for indicating whether tap coefficients of all filters in a plurality of filter banks supporting sharing of a nonlinear clipping index use the shared nonlinear clipping index. By way of example, at a coder side, whether to use the shared nonlinear clipping index for the tap coefficients of all the filters in the plurality of supportable filter banks may be determined by using an RDO cost. When determining that the plurality of filter banks support tap coefficients of all filters to use the shared nonlinear clipping index, the coder determines a value of a first flag and writes the first flag and the value thereof into the bitstream. Therefore, the electronic device may obtain the value of the first flag by parsing the bitstream.

By way of example, the first flag may be represented as “alf_alt_share_nonlinear_flag”. If a value of alf_alt_share_nonlinear_flag is a second value (e.g., “0”), it indicates that the shared nonlinear clipping index is not used for the tap coefficients of all the filters in the plurality of filter banks. If the value of alf_alt_share_nonlinear_flag is a first value (e.g., “1”), it indicates that the shared nonlinear clipping index is used for the tap coefficients of all the filters in the plurality of filter banks.
S2420: Determine, if the value of the first flag is a second value, a value of a second flag, and write the second flag and the value thereof into a bitstream, the second flag being configured for indicating whether at least one first target filter bank exists, where tap coefficients of at least one filter included in the first target filter bank use the shared nonlinear clipping index.

As described above, if the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether a first target filter bank exists, where tap coefficients of at least one filter included in the first target filter bank use the shared nonlinear clipping index.

By way of example, the electronic device parses the bitstream to determine a value of a second flag. The second flag is configured for indicating whether at least one first target filter bank exists, where tap coefficients of at least one filter included in the first target filter bank use the shared nonlinear clipping index. By way of example, at a coder side, whether the first target filter bank exists in the plurality of filter banks may be determined by using an RDO cost. When determining that the first target filter bank exists in the plurality of filter banks supporting sharing of the nonlinear clipping index, the coder determines a value of a second flag and writes the second flag and the value thereof into the bitstream.

Therefore, the electronic device may obtain the value of the second flag by parsing the bitstream.

By way of example, the second flag may be represented as “alf_alt_has_filter_share_nonlinear”. If a value of alf_alt_has_filter_share_nonlinear is a second value (e.g., “0”), it indicates that none of a plurality of filter banks supporting sharing of a nonlinear clipping index shares the nonlinear clipping index. If the value of alf_alt_has_filter_share_nonlinear is a first value (e.g., “1”), it indicates that the at least one first target filter bank exists in the plurality of filter banks.
S2430: Determine, if the value of the second flag is a first value, a value of a third flag corresponding to each filter bank, and write the third flag and the value thereof into the bitstream, the third flag being configured for indicating whether a current filter bank is the first target filter bank.

A specific implementation of S2430 is the same as that of S2120. Details are not described herein again.
S2440: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

A specific implementation of S2440 is the same as that of S2130. Details are not described herein again.
S2450: Write, if the value of the fourth flag is a first value, a second nonlinear clipping index into the bitstream, the second nonlinear clipping index being the nonlinear clipping index shared by the tap coefficients of the filter.

A specific implementation of S2450 is the same as that of S2140. Details are not described herein again.

In the solution provided in Embodiment 27, for the plurality of tap coefficients of the determined filter, only one shared second nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 28

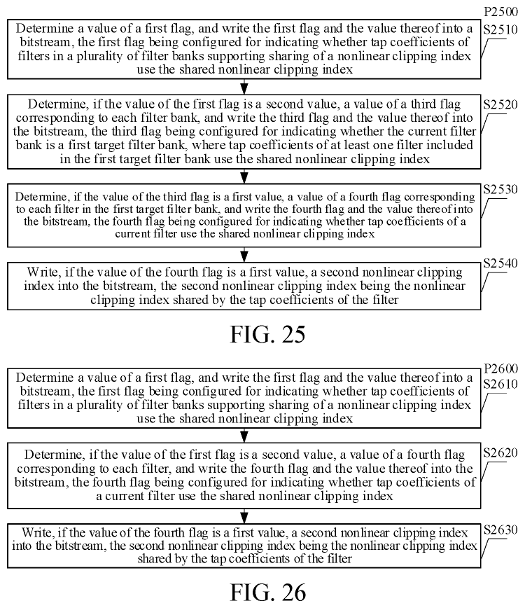

Based on Embodiment 20, Embodiment 28 of the present disclosure also provides a coding method P2500. All implementations recorded in Embodiment 20 may be applied to Embodiment 28, and can achieve the same technical effect. FIG. 25 is a schematic flowchart of a coding method P2500 according to some embodiments of the present disclosure. In the some embodiments, operations illustrated in FIG. 25 may be performed sequentially, in a different order, in parallel, or with some operations skipped or repeated.
S2510: Determine a value of a first flag, and write the first flag and the value thereof into a bitstream, the first flag being configured for indicating whether tap coefficients of filters in a plurality of filter banks supporting sharing of a nonlinear clipping index use the shared nonlinear clipping index.

A specific implementation of S2510 is the same as that of S2410. Details are not described herein again.
S2520: Determine, if the value of the first flag is a second value, a value of a third flag corresponding to each filter bank, and write the third flag and the value thereof into the bitstream, the third flag being configured for indicating whether the current filter bank is a first target filter bank, where tap coefficients of at least one filter included in the first target filter bank use the shared nonlinear clipping index.

If the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether a current filter bank belongs to a first target filter bank, where tap coefficients of at least one filter included in the first target filter bank use the shared nonlinear clipping index.

By way of example, the electronic device parses the bitstream to determine a value of a third flag. The third flag is configured for indicating whether a current filter bank is a first target filter bank, where tap coefficients of at least one filter included in the first target filter bank use the shared nonlinear clipping index. By way of example, at a coder side, whether a current filter bank belongs to the first target filter bank may be determined by using an RDO cost. When determining that the first target filter bank exists in the current filter bank, the coder determines a value of a third flag and writes the third flag and the value thereof into the bitstream. Therefore, the electronic device may obtain the value of the third flag by parsing the bitstream.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S2530: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

A specific implementation of S2530 is the same as that of S2130. Details are not described herein again.
S2540: Write, if the value of the fourth flag is a first value, a second nonlinear clipping index into the bitstream, the second nonlinear clipping index being the nonlinear clipping index shared by the tap coefficients of the filter.

A specific implementation of S2540 is the same as that of S2140. Details are not described herein again.

In the solution provided in Embodiment 28, for the plurality of tap coefficients of the determined filter, only one shared second nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 29

Based on Embodiment 20, Embodiment 29 of the present disclosure also provides a coding method P2600. All implementations recorded in Embodiment 20 may be applied to Embodiment 29, and can achieve the same technical effect. FIG. 26 is a schematic flowchart of a coding method P2600 according to some embodiments of the present disclosure. In the some embodiments, operations illustrated in FIG. 26 may be performed sequentially, in a different order, in parallel, or with some operations skipped or repeated.
S2610: Determine a value of a first flag, and write the first flag and the value thereof into a bitstream, the first flag being configured for indicating whether tap coefficients of filters in a plurality of filter banks supporting sharing of a nonlinear clipping index use the shared nonlinear clipping index.

A specific implementation of S2610 is the same as that of S2410. Details are not described herein again.
S2620: Determine, if the value of the first flag is a second value, a value of a fourth flag corresponding to each filter, and write the fourth flag and the value thereof into the bitstream, the fourth flag being configured for indicating whether tap coefficients of a current filter use the shared nonlinear clipping index.

If the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether tap coefficients of a current filter use the shared nonlinear clipping index.

By way of example, the electronic device parses the bitstream to determine a value of a fourth flag. The fourth flag is configured for indicating whether tap coefficients of a current filter use the shared nonlinear clipping index. By way of example, at a coder side, whether to use the shared nonlinear clipping index for tap coefficients of a current filter may be determined by using an RDO cost. When determining that the tap coefficients of the current filter use the shared nonlinear clipping index, the coder determines a value of a fourth flag and writes the fourth flag and the value thereof into the bitstream. Therefore, the electronic device may obtain the value of the fourth flag by parsing the bitstream.

By way of example, the fourth flag may be represented as “alf_filter_share_nonlinear”. If a value of alf_filter_share_nonlinear is a second value (e.g., “O”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S2630: Write, if the value of the fourth flag is a first value, a second nonlinear clipping index into the bitstream, the second nonlinear clipping index being the nonlinear clipping index shared by the tap coefficients of the filter.

When the value of the fourth flag alf_filter_share_nonlinear is a first value (e.g., “1”), the electronic device may parse the bitstream, to determine a second nonlinear clipping index, which is exemplarily represented as “alf_filter_shared_nonlinear_idx”. Therefore, the second nonlinear clipping index “alf_filter_shared_nonlinear_idx” may represent the nonlinear clipping index shared by the tap coefficients of the current filter.

In the solution provided in Embodiment 29, for the plurality of tap coefficients of the determined filter, only one shared second nonlinear clipping index needs to be transmitted, to implement a nonlinear clipping operation on an input of the filter. Therefore, bit overheads of the nonlinear clipping indexes can be reduced, thereby facilitating improving video compression efficiency.

### Embodiment 30

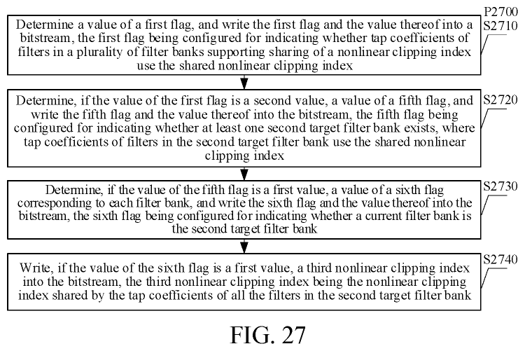

Based on Embodiment 20, Embodiment 30 of the present disclosure also provides a coding method P2700. All implementations recorded in Embodiment 20 may be applied to Embodiment 30, and can achieve the same technical effect. FIG. 27 is a schematic flowchart of a coding method P2700 according to some embodiments of the present disclosure. In the some embodiments, operations illustrated in FIG. 27 may be performed sequentially, in a different order, in parallel, or with some operations skipped or repeated.
S2710: Determine a value of a first flag, and write the first flag and the value thereof into a bitstream, the first flag being configured for indicating whether tap coefficients of filters in a plurality of filter banks supporting sharing of a nonlinear clipping index use the shared nonlinear clipping index.

A specific implementation of S2710 is the same as that of S2410. Details are not described herein again.
S2720: Determine, if the value of the first flag is a second value, a value of a fifth flag, and write the fifth flag and the value thereof into the bitstream, the fifth flag being configured for indicating whether at least one second target filter bank exists, where tap coefficients of filters in the second target filter bank use the shared nonlinear clipping index.

If the value of the first flag alf_alt_share_nonlinear_flag is a second value (e.g., “0”), it indicates that the shared nonlinear clipping index is not used for tap coefficients of all filters in the plurality of filter banks. The electronic device needs to parse the bitstream to determine whether a second target filter bank exists in the plurality of filter banks, where tap coefficients of filters in the second target filter bank use the shared nonlinear clipping index.

By way of example, the electronic device parses the bitstream to determine a value of a fifth flag. By way of example, at a coder side, whether the second target filter bank exists in the plurality of filter banks may be determined by using an RDO cost. When determining that the second target filter bank exists in the plurality of filter banks supporting sharing of the nonlinear clipping index, the coder determines a value of a fifth flag and writes the fifth flag and the value thereof into the bitstream. Therefore, the electronic device may obtain the value of the fifth flag by parsing the bitstream.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. No additional syntax elements related to the shared nonlinear index need to be transmitted. If the value of alf_has_filterset_share_nonlinear is a first value (e.g., “1”), it indicates that the at least one second target filter bank exists in the plurality of filter banks.
S2730: Determine, if the value of the fifth flag is a first value, a value of a sixth flag corresponding to each filter bank, and write the sixth flag and the value thereof into the bitstream, the sixth flag being configured for indicating whether a current filter bank is the second target filter bank.

A specific implementation of S2730 is the same as that of S2320. Details are not described herein again.
S2740: Write, if the value of the sixth flag is a first value, a third nonlinear clipping index into the bitstream, the third nonlinear clipping index being the nonlinear clipping index shared by the tap coefficients of the filters in the second target filter bank.

A specific implementation of S2740 is the same as that of S2330. Details are not described herein again.

In the solution provided in Embodiment 30, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 31

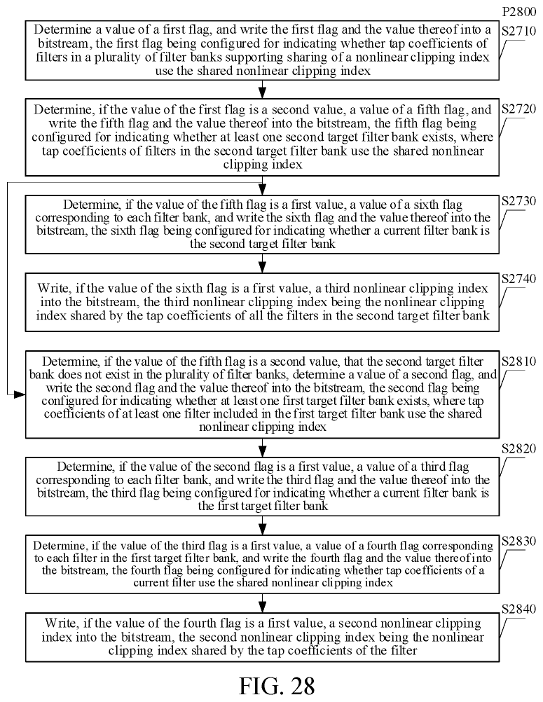

Based on Embodiment 20, Embodiment 31 of the present disclosure also provides a coding method P2800. All implementations recorded in Embodiment 20 may be applied to Embodiment 31, and can achieve the same technical effect. FIG. 28 is a schematic flowchart of a coding method P2800 according to some embodiments of the present disclosure. In the some embodiments, operations illustrated in FIG. 28 may be performed sequentially, in a different order, in parallel, or with some operations skipped or repeated. Referring to FIG. 28, the method P2800 is implemented based on the method P2700. The method P2800 includes S2710 to S2740 and S2810 to S2840.

Specific implementations of S2710 to S2740 are described in detail in the foregoing embodiments. Details are not described herein again.
S2810: Determine, if the value of the fifth flag is a second value, that the second target filter bank does not exist in the plurality of filter banks, determine a value of a second flag, and write the second flag and the value thereof into the bitstream, the second flag being configured for indicating whether at least one first target filter bank exists, where tap coefficients of at least one filter included in the first target filter bank use the shared nonlinear clipping index.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. To be specific, the second target filter bank does not exist. Then, the electronic device parses the bitstream to determine whether a first target filter bank exists in all the supported filter banks.

By way of example, the electronic device parses the bitstream to determine a value of a second flag. The second flag is configured for indicating whether at least one first target filter bank exists, where tap coefficients of at least one filter included in the first target filter bank use the shared nonlinear clipping index. By way of example, at a coder side, whether the first target filter bank exists in the plurality of filter banks may be determined by using an RDO cost. When determining that the first target filter bank exists in the plurality of filter banks supporting sharing of the nonlinear clipping index, the coder determines a value of a second flag and writes the second flag and the value thereof into the bitstream. Therefore, the electronic device may obtain the value of the second flag by parsing the bitstream.

By way of example, the second flag may be represented as “alf_alt_has_filter_share_nonlinear”. If a value of alf_alt_has_filter_share_nonlinear is a second value (e.g., “0”), it indicates that none of a plurality of filter banks supporting sharing of a nonlinear clipping index shares the nonlinear clipping index. If the value of alf_alt_has_filter_share_nonlinear is a first value (e.g., “1”), it indicates that the at least one first target filter bank exists in the plurality of filter banks.
S2820: Determine, if the value of the second flag is a first value, a value of a third flag corresponding to each filter bank, and write the third flag and the value thereof into the bitstream, the third flag being configured for indicating whether a current filter bank is the first target filter bank.

A specific implementation of S2820 is the same as that of S2120. Details are not described herein again.
S2830: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

A specific implementation of S2830 is the same as that of S2130. Details are not described herein again.
S2840: Write, if the value of the fourth flag is a first value, a second nonlinear clipping index into the bitstream, the second nonlinear clipping index being the nonlinear clipping index shared by the tap coefficients of the filter.

A specific implementation of S2840 is the same as that of S2140. Details are not described herein again.

In the solution provided in Embodiment 31, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 32

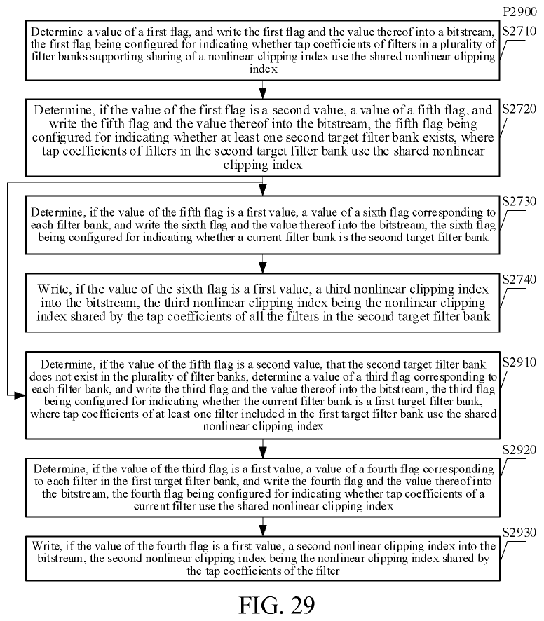

Based on Embodiment 20, Embodiment 32 of the present disclosure also provides a coding method P2900. All implementations recorded in Embodiment 20 may be applied to Embodiment 32, and can achieve the same technical effect. FIG. 29 is a schematic flowchart of a coding method P2900 according to some embodiments of the present disclosure. In the some embodiments, operations illustrated in FIG. 29 may be performed sequentially, in a different order, in parallel, or with some operations skipped or repeated. Referring to FIG. 29, the method P2900 is implemented based on the method P2700. The method P2900 includes S2710 to S2740 and S2910 to S2930.

Specific implementations of S2710 to S2740 are described in detail in the foregoing embodiments. Details are not described herein again.
S2910: Determine, if the value of the fifth flag is a second value, that the second target filter bank does not exist in the plurality of filter banks, determine a value of a third flag corresponding to each filter bank, and write the third flag and the value thereof into the bitstream, the third flag being configured for indicating whether the current filter bank is a first target filter bank, where tap coefficients of at least one filter included in the first target filter bank use the shared nonlinear clipping index.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. To be specific, the second target filter bank does not exist.

To determine, in all supported filter banks, which filter bank belongs to the first target filter bank, the electronic device needs to determine a third flag corresponding to an i^{th} (i is an integer having a value of 1 to Y in sequence) filter bank among all the supported filter banks (assuming that Y filter banks are included). The third flag of the i^{th} filter bank is configured for indicating whether the i^{th} filter bank is the first target filter bank. To be specific, tap coefficients of at least one filter included in the i^{th} filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S2920: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

A specific implementation of S2920 is the same as that of S2130. Details are not described herein again.
S2930: Write, if the value of the fourth flag is a first value, a second nonlinear clipping index into the bitstream, the second nonlinear clipping index being the nonlinear clipping index shared by the tap coefficients of the filter.

A specific implementation of S2930 is the same as that of S2140. Details are not described herein again.

In the solution provided in Embodiment 32, for the plurality of respective tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 33

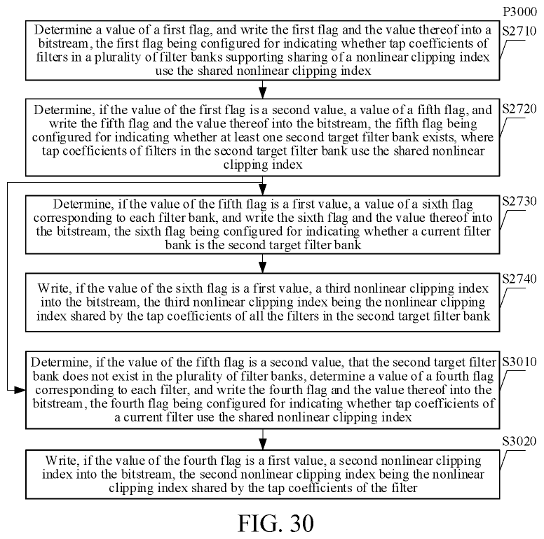

Based on Embodiment 20, Embodiment 33 of the present disclosure also provides a coding method P3000. All implementations recorded in Embodiment 20 may be applied to Embodiment 33, and can achieve the same technical effect. FIG. 30 is a schematic flowchart of a coding method P3000 according to some embodiments of the present disclosure. In the some embodiments, operations illustrated in FIG. 30 may be performed sequentially, in a different order, in parallel, or with some operations skipped or repeated. Referring to FIG. 30, the method P3000 is implemented based on the method P2700. The method P3000 includes S2710 to S2740 and S3010 to S3020.

Specific implementations of S2710 to S2740 are described in detail in the foregoing embodiments. Details are not described herein again.
S3010: Determine, if the value of the fifth flag is a second value, that the second target filter bank does not exist in the plurality of filter banks, determine a value of a fourth flag corresponding to each filter, and write the fourth flag and the value thereof into the bitstream, the fourth flag being configured for indicating whether tap coefficients of a current filter use the shared nonlinear clipping index.

By way of example, the fifth flag may be represented as “alf_has_filterset_share_nonlinear”. If a value of alf_has_filterset_share_nonlinear is a second value (e.g., “0”), it indicates that none of filters in all supported filter banks uses the shared nonlinear clipping index. To be specific, the second target filter bank does not exist.

To determine, from all supported filter banks, which filter in the first target filter bank has tap coefficients sharing the nonlinear clipping index, a value of a fourth flag corresponding to each filter in all the supported filter banks needs to be determined. Assuming that all the supported filter banks include X filters, a fourth flag of a j^{th} filter (j is an integer having a value of 1 to X in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “O”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S3020: Write, if the value of the fourth flag is a first value, a second nonlinear clipping index into the bitstream, the second nonlinear clipping index being the nonlinear clipping index shared by the tap coefficients of the filter.

A specific implementation of S3020 is the same as that of S2140. Details are not described herein again.

In the solution provided in Embodiment 33, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 34

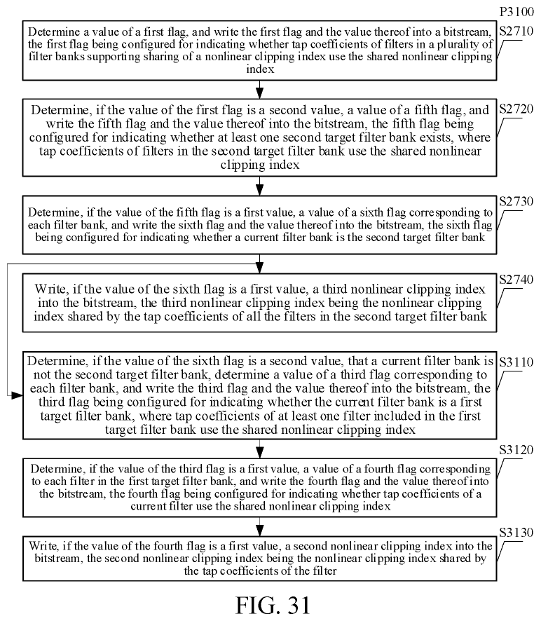

Based on Embodiment 20, Embodiment 34 of the present disclosure also provides a coding method P3100. All implementations recorded in Embodiment 20 may be applied to Embodiment 34, and can achieve the same technical effect. FIG. 31 is a schematic flowchart of a coding method P3100 according to some embodiments of the present disclosure. In the some embodiments, operations illustrated in FIG. 31 may be performed sequentially, in a different order, in parallel, or with some operations skipped or repeated. Referring to FIG. 31, the method P3100 is implemented based on the method P2700. The method P3100 includes S2710 to S2740 and S3110 to S3130.

Specific implementations of S2710 to S2740 are described in detail in the foregoing embodiments. Details are not described herein again.
S3110: Determine, if the value of the sixth flag is a second value, that a current filter bank is not the second target filter bank, determine a value of a third flag corresponding to each filter bank, and write the third flag and the value thereof into the bitstream, the third flag being configured for indicating whether the current filter bank is a first target filter bank, where tap coefficients of at least one filter included in the first target filter bank use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine whether the current filter bank belongs to the first target filter bank, the electronic device performs decoding to determine a third flag corresponding to the current filter bank. The third flag of the current filter bank is configured for indicating whether the current filter bank is the first target filter bank. To be specific, tap coefficients of at least one filter included in the current filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S3120: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

A specific implementation of S3120 is the same as that of S2130. Details are not described herein again.
S3130: Write, if the value of the fourth flag is a first value, a second nonlinear clipping index into the bitstream, the second nonlinear clipping index being the nonlinear clipping index shared by the tap coefficients of the filter.

A specific implementation of S3130 is the same as that of S2140. Details are not described herein again.

In the solution provided in Embodiment 34, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 35

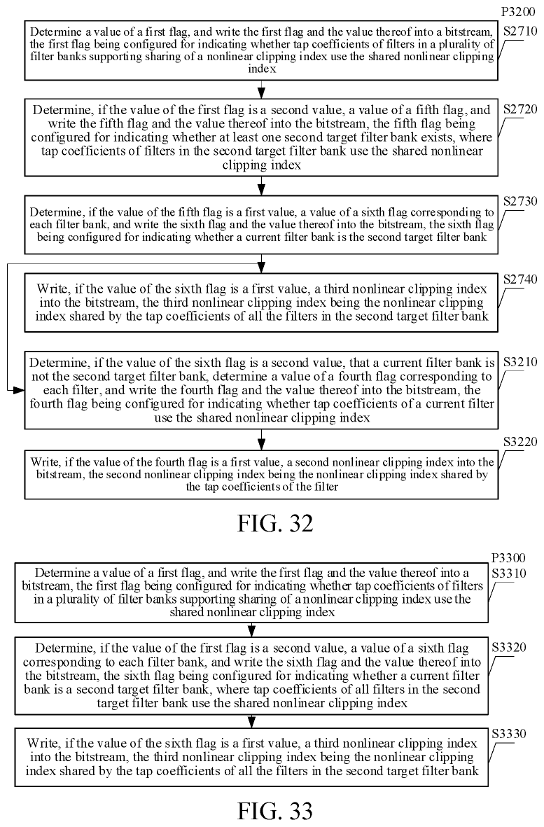

Based on Embodiment 20, Embodiment 35 of the present disclosure also provides a coding method P3200. All implementations recorded in Embodiment 20 may be applied to Embodiment 35, and can achieve the same technical effect. FIG. 32 is a schematic flowchart of a coding method P3200 according to some embodiments of the present disclosure. In the some embodiments, operations illustrated in FIG. 32 may be performed sequentially, in a different order, in parallel, or with some operations skipped or repeated. Referring to FIG. 32, the method P3200 is implemented based on the method P2700. The method P3200 includes S2710 to S2740 and S3210 to S3220.

Specific implementations of S2710 to S2740 are described in detail in the foregoing embodiments. Details are not described herein again.
S3210: Determine, if the value of the sixth flag is a second value, that a current filter bank is not the second target filter bank, determine a value of a fourth flag corresponding to each filter, and write the fourth flag and the value thereof into the bitstream, the fourth flag being configured for indicating whether tap coefficients of a current filter use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine, from a current filter bank, which filter in the first target filter bank has tap coefficients sharing the nonlinear clipping index, a value of a fourth flag corresponding to each filter in the current filter bank needs to be determined. Assuming that the current filter bank includes Z filters, a fourth flag of a j^{th} filter (j is an integer having a value of 1 to Z in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “O”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S3220: Write, if the value of the fourth flag is a first value, a second nonlinear clipping index into the bitstream, the second nonlinear clipping index being the nonlinear clipping index shared by the tap coefficients of the filter.

A specific implementation of S3220 is the same as that of S2140. Details are not described herein again.

In the solution provided in Embodiment 35, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 36

Based on Embodiment 20, Embodiment 36 of the present disclosure also provides a coding method P3300. All implementations recorded in Embodiment 20 may be applied to Embodiment 36, and can achieve the same technical effect. FIG. 33 is a schematic flowchart of a coding method P3300 according to some embodiments of the present disclosure. In the some embodiments, operations illustrated in FIG. 33 may be performed sequentially, in a different order, in parallel, or with some operations skipped or repeated.
S3310: Determine a value of a first flag, and write the first flag and the value thereof into a bitstream, the first flag being configured for indicating whether tap coefficients of filters in a plurality of filter banks supporting sharing of a nonlinear clipping index use the shared nonlinear clipping index.

A specific implementation of S3310 is the same as that of S2410. Details are not described herein again.
S3320: Determine, if the value of the first flag is a second value, a value of a sixth flag corresponding to each filter bank, and write the sixth flag and the value thereof into the bitstream, the sixth flag being configured for indicating whether a current filter bank is a second target filter bank, where tap coefficients of filters in the second target filter bank use the shared nonlinear clipping index.

If the value of the first flag alf_alt_share_nonlinear_flag is a second value (e.g., “0”), it indicates that the shared nonlinear clipping index is not used for tap coefficients of all filters in a plurality of supportable filter banks. The electronic device needs to parse the bitstream to determine whether a second target filter bank exists, where tap coefficients of filters in the second target filter bank use the shared nonlinear clipping index.

To further determine which filter bank belongs to the second target filter bank, the electronic device parses the bitstream to determine a value of a sixth flag corresponding to each filter bank. By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index. If the value of alf_filterset_share_nonlinear_flag is a first value (e.g., “1”), it indicates that the current filter bank belongs to the second target filter bank. To be specific, tap coefficients of all filters in the current filter bank use the shared nonlinear clipping index.
S3330: Write, if the value of the sixth flag is a first value, a third nonlinear clipping index into the bitstream, the third nonlinear clipping index being the nonlinear clipping index shared by the tap coefficients of the filters in the second target filter bank.

A specific implementation of S3330 is the same as that of S2330. Details are not described herein again.

In the solution provided in Embodiment 36, for the plurality of tap coefficients respectively corresponding to all filters in the current filter bank, only one shared nonlinear clipping index needs to be transmitted, to implement a nonlinear clipping operation on inputs of all filters in the filter bank. Therefore, bit overheads of the nonlinear clipping indexes can be significantly reduced, thereby facilitating improving video compression efficiency.

### Embodiment 37

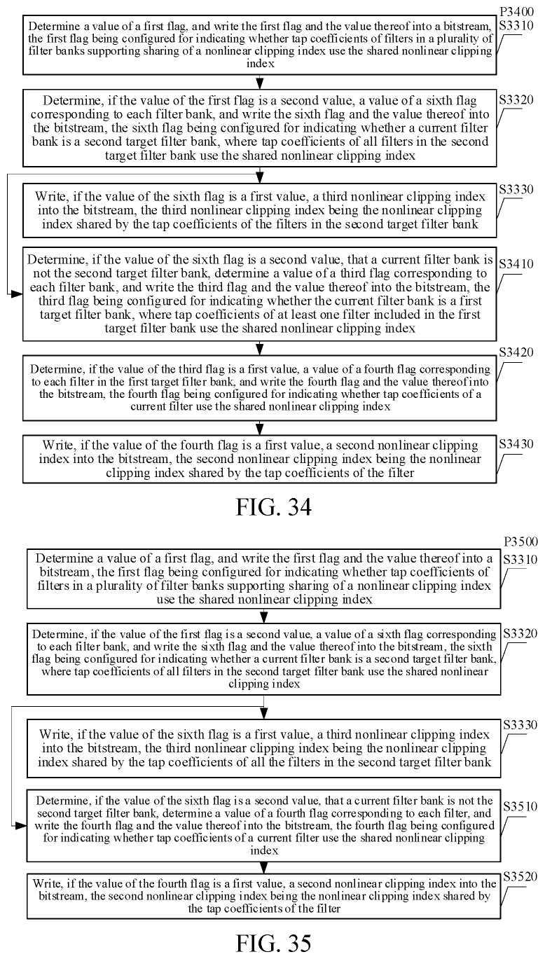

Based on Embodiment 20, Embodiment 37 of the present disclosure also provides a coding method P3400. All implementations recorded in Embodiment 20 may be applied to Embodiment 37, and can achieve the same technical effect. FIG. 34 is a schematic flowchart of a coding method P3400 according to some embodiments of the present disclosure. In the some embodiments, operations illustrated in FIG. 34 may be performed sequentially, in a different order, in parallel, or with some operations skipped or repeated. Referring to FIG. 34, the method P3400 is implemented based on the method P3300. The method P3400 includes S3310 to S3330 and S3410 to S3430.

Specific implementations of S3310 to S3330 are described in detail in the foregoing embodiments. Details are not described herein again.
S3410: Determine, if the value of the sixth flag is a second value, that a current filter bank is not the second target filter bank, determine a value of a third flag corresponding to each filter bank, and write the third flag and the value thereof into the bitstream, the third flag being configured for indicating whether the current filter bank is a first target filter bank, where tap coefficients of at least one filter included in the first target filter bank use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine whether the current filter bank belongs to the first target filter bank, the electronic device performs decoding to determine a third flag corresponding to the current filter bank. The third flag of the current filter bank is configured for indicating whether the current filter bank is the first target filter bank. To be specific, tap coefficients of at least one filter included in the current filter bank use the shared nonlinear clipping index.

By way of example, the third flag may be represented as “alf_filterset_has_filter_share_nonlinear”. If a value of alf_filterset_has_filter_share_nonlinear is a second value (e.g., “0”), it indicates that a current filter bank does not belong to the first target filter bank. To be specific, the current filter bank does not include a filter having tap coefficients using the shared nonlinear clipping index. If the value of alf_filterset_has_filter_share_nonlinear is a first value (e.g., “1”), it indicates that the current filter bank belongs to the first target filter bank. To be specific, tap coefficients of at least one filter included in the current filter bank use the shared nonlinear clipping index.
S3420: Determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index.

A specific implementation of S3420 is the same as that of S2130. Details are not described herein again.
S3430: Write, if the value of the fourth flag is a first value, a second nonlinear clipping index into the bitstream, the second nonlinear clipping index being the nonlinear clipping index shared by the tap coefficients of the filter.

A specific implementation of S3430 is the same as that of S2140. Details are not described herein again.

In the solution provided in Embodiment 37, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

### Embodiment 38

Based on Embodiment 20, Embodiment 38 of the present disclosure also provides a coding method P3500. All implementations recorded in Embodiment 20 may be applied to Embodiment 38, and can achieve the same technical effect. FIG. 35 is a schematic flowchart of a coding method P3500 according to some embodiments of the present disclosure. In the some embodiments, operations illustrated in FIG. 35 may be performed sequentially, in a different order, in parallel, or with some operations skipped or repeated. Referring to FIG. 35, the method P3500 is implemented based on the method P3300. The method P3500 includes S3310 to S3330 and S3510 to S3520.

Specific implementations of S3310 to S3330 are described in detail in the foregoing embodiments. Details are not described herein again.
S3510: Determine, if the value of the sixth flag is a second value, that a current filter bank is not the second target filter bank, determine a value of a fourth flag corresponding to each filter, and write the fourth flag and the value thereof into the bitstream, the fourth flag being configured for indicating whether tap coefficients of a current filter use the shared nonlinear clipping index.

By way of example, the sixth flag may be represented as “alf_filterset_share_nonlinear_flag”. If a value of alf_filterset_share_nonlinear_flag is a second value (e.g., “0”), it indicates that a current filter bank does not belong to the second target filter bank. To be specific, tap coefficients of not all filters in the current filter bank use the shared nonlinear clipping index.

To determine, from a current filter bank, which filter in the first target filter bank has tap coefficients sharing the nonlinear clipping index, a value of a fourth flag corresponding to each filter in the current filter bank needs to be determined. Assuming that the current filter bank includes Z filters, a fourth flag of a j^{th} filter (j is an integer having a value of 1 to Z in sequence) is configured for indicating whether tap coefficients of the j^{th} filter share the nonlinear clipping index.

By way of example, the fourth flag may be represented as “alf_filter_share_nonlinear”. If a value of alf_filter_share_nonlinear is a second value (e.g., “0”), it indicates that tap coefficients of a current filter do not use the shared nonlinear clipping index. If the value of alf_filter_share_nonlinear is a first value (e.g., “1”), it indicates that the tap coefficients of the current filter use the shared nonlinear clipping index.
S3520: Write, if the value of the fourth flag is a first value, a second nonlinear clipping index into the bitstream, the second nonlinear clipping index being the nonlinear clipping index shared by the tap coefficients of the filter.

A specific implementation of S3520 is the same as that of S2140. Details are not described herein again.

In the solution provided in Embodiment 38, for the plurality of tap coefficients of the current filter, only one shared nonlinear clipping index needs to be transmitted, to implement a nonlinear clipping operation on an input of the filter. Therefore, bit overheads of the nonlinear clipping indexes can be significantly reduced, thereby facilitating improving video compression efficiency.

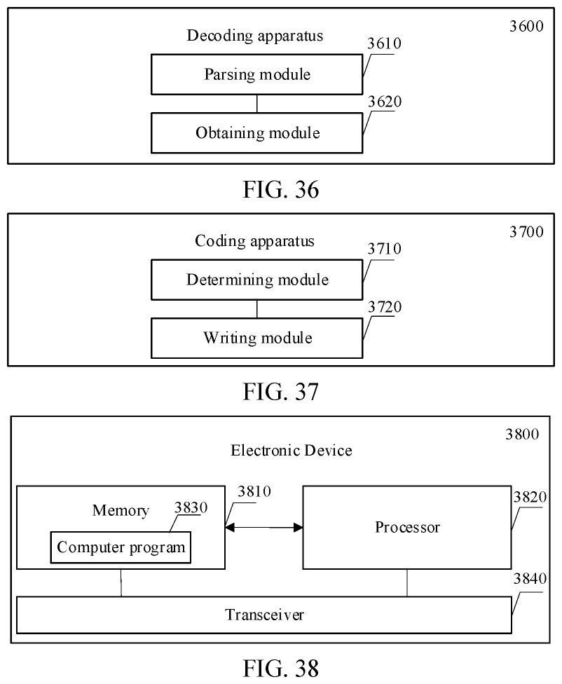

The coding/decoding method embodiments of the present disclosure are described in detail above with reference to FIG. 4 to FIG. 35. Apparatus embodiments of the present disclosure will be described below in detail with reference to FIG. 36 and FIG. 37.

FIG. 36 is a schematic structural diagram of a decoding apparatus 3600 according to some embodiments of the present disclosure. Referring to FIG. 36, the decoding apparatus 3600 includes a parsing module 3610 and an obtaining module 3620.

The parsing module 3610 is configured to parse a bitstream, to determine a target flag and a value of the target flag, the target flag being configured for indicating whether tap coefficients of at least one filter use a shared nonlinear clipping index. In addition, the obtaining module 3620 is configured to obtain, if the value of the target flag is a first value, a target nonlinear clipping index from the bitstream, the target nonlinear clipping index being the nonlinear clipping index shared by the tap coefficients of the at least one filter.

In an exemplary embodiment, based on the foregoing solution, the target flag includes a first flag, the first flag being configured for indicating whether tap coefficients of all filters in a plurality of filter banks supporting sharing of a nonlinear clipping index use the shared nonlinear clipping index. The target nonlinear clipping index includes a first nonlinear clipping index, the first nonlinear clipping index being the nonlinear clipping index shared by the tap coefficients of all the filters in the plurality of filter banks.

In an exemplary embodiment, based on the foregoing solution, the target flag includes a second flag, the second flag being configured for indicating whether at least one first target filter bank exists, where tap coefficients of at least one filter included in the first target filter bank use the shared nonlinear clipping index.

The parsing module 3610 is further configured to: parse, if a value of the second flag is a first value, the bitstream to determine a third flag corresponding to each filter bank, the third flag being configured for indicating whether a current filter bank is the first target filter bank; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the target flag includes a third flag corresponding to each filter bank, the third flag being configured for indicating whether a current filter bank is a first target filter bank, where tap coefficients of at least one filter included in the first target filter bank use the shared nonlinear clipping index.

The parsing module 3610 is further configured to: parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the target flag includes a fourth flag corresponding to each filter, the fourth flag being configured for indicating whether tap coefficients of a current filter use the shared nonlinear clipping index. The target nonlinear clipping index includes a second nonlinear clipping index, the second nonlinear clipping index being the nonlinear clipping index shared by the tap coefficients of the filter.

In an exemplary embodiment, based on the foregoing solution, the target flag includes a fifth flag, the fifth flag being configured for indicating whether at least one second target filter bank exists, where tap coefficients of filters in the second target filter bank use the shared nonlinear clipping index.

The parsing module 3610 is further configured to: parse, if a value of the fifth flag is a first value, the bitstream to determine a sixth flag corresponding to each filter bank, the sixth flag being configured for indicating whether a current filter bank is the second target filter bank; and obtain, if a value of the sixth flag is a first value, a third nonlinear clipping index, the third nonlinear clipping index being the nonlinear clipping index shared by the tap coefficients of the filters in the second target filter bank.

In an exemplary embodiment, based on the foregoing solution, the target flag includes a sixth flag corresponding to each filter bank, the sixth flag being configured for indicating whether a current filter bank is a second target filter bank, where tap coefficients of filters in the second target filter bank use the shared nonlinear clipping index. The target nonlinear clipping index includes a third nonlinear clipping index, the third nonlinear clipping index being the nonlinear clipping index shared by the tap coefficients of the filters in the second target filter bank.

In an exemplary embodiment, based on the foregoing solution, the parsing module 3610 is further configured to: parse, if a value of the first flag is a second value, the bitstream to determine a second flag, the second flag being configured for indicating whether at least one first target filter bank exists, where tap coefficients of at least one filter included in the first target filter bank use the shared nonlinear clipping index; parse, if a value of the second flag is a first value, the bitstream to determine a third flag corresponding to each filter bank, the third flag being configured for indicating whether a current filter bank is the first target filter bank; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: parse, if a value of the first flag is a second value, the bitstream to determine a third flag corresponding to each filter bank, the third flag being configured for indicating whether a current filter bank is a first target filter bank, where tap coefficients of at least one filter included in the first target filter bank use the shared nonlinear clipping index; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: parse, if a value of the first flag is a second value, the bitstream to determine a fourth flag corresponding to each filter, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: parse, if a value of the first flag is a second value, the bitstream to determine a fifth flag, the fifth flag being configured for indicating whether at least one second target filter bank exists, where tap coefficients of filters in the second target filter bank use the shared nonlinear clipping index; parse, if a value of the fifth flag is a first value, a bitstream to determine a sixth flag corresponding to each filter bank, the sixth flag being configured for indicating whether a current filter bank is the second target filter bank; and obtain, if a value of the sixth flag is a first value, a third nonlinear clipping index, the third nonlinear clipping index being the nonlinear clipping index shared by the tap coefficients of the filters in the second target filter bank.

In an exemplary embodiment, based on the foregoing solution, the parsing module 3610 is further configured to: determine, if the value of the fifth flag is a second value, that the second target filter bank does not exist in the plurality of filter banks, and parse the bitstream to determine a second flag, the second flag being configured for indicating whether at least one first target filter bank exists, where tap coefficients of at least one filter included in the first target filter bank use the shared nonlinear clipping index; parse, if a value of the second flag is a first value, the bitstream to determine a third flag corresponding to each filter bank, the third flag being configured for indicating whether a current filter bank is the first target filter bank; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: determine, if the value of the fifth flag is a second value, that the second target filter bank does not exist in the plurality of filter banks, and parse the bitstream to determine a third flag corresponding to each filter bank, the third flag being configured for indicating whether a current filter bank is a first target filter bank, where tap coefficients of at least one filter included in the first target filter bank use the shared nonlinear clipping index; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: determine, if the value of the fifth flag is a second value, that the second target filter bank does not exist in the plurality of filter banks, and parse the bitstream to determine a fourth flag corresponding to each filter, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: determine, if the value of the sixth flag is a second value, that a current filter bank is not the second target filter bank, and parse the bitstream to determine a third flag corresponding to each filter bank, the third flag being configured for indicating whether the current filter bank is a first target filter bank, where tap coefficients of at least one filter included in the first target filter bank use the shared nonlinear clipping index; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: determine, if the value of the sixth flag is a second value, that a current filter bank is not the second target filter bank, and parse the bitstream to determine a fourth flag corresponding to each filter, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: parse, if a value of the first flag is a second value, the bitstream to determine a sixth flag corresponding to each filter bank, the sixth flag being configured for indicating whether a current filter bank is a second target filter bank, where tap coefficients of filters in the second target filter bank use the shared nonlinear clipping index; and obtain, if a value of the sixth flag is a first value, a third nonlinear clipping index, the third nonlinear clipping index being the nonlinear clipping index shared by the tap coefficients of the filters in the second target filter bank.

In an exemplary embodiment, based on the foregoing solution, the parsing module 3610 is further configured to: determine, if the value of the sixth flag is a second value, that a current filter bank is not the second target filter bank, and parse the bitstream to determine a third flag corresponding to each filter bank, the third flag being configured for indicating whether the current filter bank is a first target filter bank, where the first target filter bank includes a nonlinear clipping index shared by tap coefficients of at least one filter; parse, if a value of the third flag is a first value, the bitstream to determine a fourth flag corresponding to each filter in the first target filter bank, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the parsing module 3610 is further configured to: determine, if the value of the sixth flag is a second value, that a current filter bank is not the second target filter bank, and parse the bitstream to determine a fourth flag corresponding to each filter, the fourth flag being configured for indicating whether tap coefficients of a current filter use the shared nonlinear clipping index; and obtain, if a value of the fourth flag is a first value, a second nonlinear clipping index, the second nonlinear clipping index being the nonlinear clipping index shared by the tap coefficients of the filter.

In an exemplary embodiment, based on the foregoing solution, the determining module 3620 is further configured to: determine, if the value of the second flag is a second value, that a filter having tap coefficients using the shared nonlinear clipping index does not exist in the plurality of filter banks; determine, if the value of the third flag is a second value, that a filter having tap coefficients using the shared nonlinear clipping index does not exist in a current filter bank; or determine, if the value of the fourth flag is a second value, that tap coefficients of a current filter do not use the shared nonlinear clipping index.

In an exemplary embodiment, based on the foregoing solution, a preset mapping relationship exists between different nonlinear clipping indexes and different nonlinear clipping intervals. The parsing module 3610 is further configured to: obtain, after obtaining a target nonlinear clipping index, a target nonlinear clipping interval having a mapping relationship with the target nonlinear clipping index, to perform a nonlinear clipping operation on an input of the at least one filter by using the target nonlinear clipping interval.

In an exemplary embodiment, based on the foregoing solution, the input of the filter includes any one or more of the following: a chroma component, a luma component, or a cross-color component. The cross-color component includes any one or more of the following: enhancing the chroma component by the luma component, enhancing a red chroma component by a blue chroma component, and enhancing the blue chroma component by the red chroma component.

The decoding apparatus embodiments and the decoding method embodiments may correspond to each other. For similar descriptions, refer to the decoding method embodiments. To avoid duplication, details are not described herein again. For example, the decoding apparatus shown in FIG. 36 may perform the foregoing embodiments of the decoding method, and the foregoing and other operations and/or functions of the modules in the apparatus are respectively intended to implement the method embodiments corresponding to nodes in a master node group. For brevity, details are not described herein again.

One or more components of FIG. 36 may be integrated into a single component, or conversely, a single component may be implemented as multiple discrete elements. Additionally or alternatively, different subsets of the illustrated components may be combined in various configurations.

FIG. 37 is a schematic structural diagram of a coding apparatus 3700 according to some embodiments of the present disclosure. The coding apparatus 3700 is configured in a terminal device. Referring to FIG. 37, the coding apparatus 3700 includes a determining module 3710 and a writing module 3720.

The determining module 3710 is configured to determine a value of a target flag, the target flag being configured for indicating whether tap coefficients of at least one filter use a shared nonlinear clipping index. The writing module 3720 is configured to write the target flag and the value thereof into a bitstream. The writing module 3720 is further configured to write, if the value of the target flag is a first value, a target nonlinear clipping index into the bitstream, the target nonlinear clipping index being the nonlinear clipping index shared by the tap coefficients of the at least one filter.

In an exemplary embodiment, based on the foregoing solution, the target flag includes a first flag, the first flag being configured for indicating whether tap coefficients of filters in a plurality of filter banks supporting sharing of a nonlinear clipping index use the shared nonlinear clipping index. The target nonlinear clipping index includes a first nonlinear clipping index, the first nonlinear clipping index being the nonlinear clipping index shared by the tap coefficients of the filters in the plurality of filter banks.

In an exemplary embodiment, based on the foregoing solution, the target flag includes a second flag, the second flag being configured for indicating whether at least one first target filter bank exists, where the first target filter bank includes a nonlinear clipping index shared by tap coefficients of at least one filter.

The writing module 3720 is further configured to: determine, if a value of the second flag is a first value, a value of a third flag corresponding to each filter bank, and write the third flag and the value thereof into the bitstream, the third flag being configured for indicating whether a current filter bank is the first target filter bank; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the target flag includes a third flag corresponding to each filter bank, the third flag being configured for indicating whether a current filter bank is a first target filter bank, where the first target filter bank includes a nonlinear clipping index shared by tap coefficients of at least one filter.

The writing module 3720 is further configured to: determine, if a value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the target flag includes a fourth flag corresponding to each filter, the fourth flag being configured for indicating whether tap coefficients of a current filter use the shared nonlinear clipping index. The target nonlinear clipping index includes a second nonlinear clipping index, the second nonlinear clipping index being the nonlinear clipping index shared by the tap coefficients of the filter.

In an exemplary embodiment, based on the foregoing solution, the target flag includes a fifth flag, the fifth flag being configured for indicating whether at least one second target filter bank exists, where tap coefficients of filters in the second target filter bank use the shared nonlinear clipping index.

The writing module 3720 is further configured to: determine, if a value of the fifth flag is a first value, a value of a sixth flag corresponding to each filter bank, and write the sixth flag and the value thereof into the bitstream, the sixth flag being configured for indicating whether a current filter bank is the second target filter bank; and write, if the value of the sixth flag is a first value, a third nonlinear clipping index into the bitstream, the third nonlinear clipping index being the nonlinear clipping index shared by the tap coefficients of the filters in the second target filter bank.

In an exemplary embodiment, based on the foregoing solution, the target flag includes a sixth flag corresponding to each filter bank, the sixth flag being configured for indicating whether a current filter bank is a second target filter bank, where tap coefficients of filters in the second target filter bank use the shared nonlinear clipping index. The target nonlinear clipping index includes a third nonlinear clipping index, the third nonlinear clipping index being the nonlinear clipping index shared by the tap coefficients of the filters in the second target filter bank.

In an exemplary embodiment, based on the foregoing solution, the writing module 3720 is further configured to: determine, if a value of the first flag is a second value, a value of a second flag, and write the second flag and the value thereof into the bitstream, the second flag being configured for indicating whether at least one first target filter bank exists, where the first target filter bank includes a nonlinear clipping index shared by tap coefficients of at least one filter; determine, if the value of the second flag is a first value, a value of a third flag corresponding to each filter bank, and write the third flag and the value thereof into the bitstream, the third flag being configured for indicating whether a current filter bank is the first target filter bank; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the first flag is a second value, a value of a third flag corresponding to each filter bank, and write the third flag and the value thereof into the bitstream, the third flag being configured for indicating whether a current filter bank is a first target filter bank, where the first target filter bank includes a nonlinear clipping index shared by tap coefficients of at least one filter; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the first flag is a second value, a value of a fourth flag corresponding to each filter, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the first flag is a second value, a value of a fifth flag, and write the fifth flag and the value thereof into the bitstream, the fifth flag being configured for indicating whether at least one second target filter bank exists, where tap coefficients of filters in the second target filter bank use the shared nonlinear clipping index; determine, if the value of the fifth flag is a first value, a value of a sixth flag corresponding to each filter bank, and write the sixth flag and the value thereof into the bitstream, the sixth flag being configured for indicating whether a current filter bank is the second target filter bank; and write, if the value of the sixth flag is a first value, a third nonlinear clipping index into the bitstream, the third nonlinear clipping index being the nonlinear clipping index shared by the tap coefficients of the filters in the second target filter bank.

In an exemplary embodiment, based on the foregoing solution, the writing module 3720 is further configured to: determine, if the value of the fifth flag is a second value, that the second target filter bank does not exist in the plurality of filter banks, determine a value of a second flag, and write the second flag and the value thereof into the bitstream, the second flag being configured for indicating whether at least one first target filter bank exists, where the first target filter bank includes a nonlinear clipping index shared by tap coefficients of at least one filter; determine, if the value of the second flag is a first value, a value of a third flag corresponding to each filter bank, and write the third flag and the value thereof into the bitstream, the third flag being configured for indicating whether a current filter bank is the first target filter bank; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the fifth flag is a second value, that the second target filter bank does not exist in the plurality of filter banks, determine a value of a third flag corresponding to each filter bank, and write the third flag and the value thereof into the bitstream, the third flag being configured for indicating whether a current filter bank is a first target filter bank, where the first target filter bank includes a nonlinear clipping index shared by tap coefficients of at least one filter; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the fifth flag is a second value, that the second target filter bank does not exist in the plurality of filter banks, determine a value of a fourth flag corresponding to each filter, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the sixth flag is a second value, that a current filter bank is not the second target filter bank, determine a value of a third flag corresponding to each filter bank, and write the third flag and the value thereof into the bitstream, the third flag being configured for indicating whether the current filter bank is a first target filter bank, where the first target filter bank includes a nonlinear clipping index shared by tap coefficients of at least one filter; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the sixth flag is a second value, that a current filter bank is not the second target filter bank, determine a value of a fourth flag corresponding to each filter, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the first flag is a second value, a value of a sixth flag corresponding to each filter bank, and write the sixth flag and the value thereof into the bitstream, the sixth flag being configured for indicating whether a current filter bank is a second target filter bank, where tap coefficients of filters in the second target filter bank use the shared nonlinear clipping index; and write, if the value of the sixth flag is a first value, a third nonlinear clipping index into the bitstream, the third nonlinear clipping index being the nonlinear clipping index shared by the tap coefficients of the filters in the second target filter bank.

In an exemplary embodiment, based on the foregoing solution, the writing module 3720 is further configured to: determine, if the value of the sixth flag is a second value, that a current filter bank is not the second target filter bank, determine a value of a third flag corresponding to each filter bank, and write the third flag and the value thereof into the bitstream, the third flag being configured for indicating whether the current filter bank is a first target filter bank, where the first target filter bank includes a nonlinear clipping index shared by tap coefficients of at least one filter; determine, if the value of the third flag is a first value, a value of a fourth flag corresponding to each filter in the first target filter bank, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, the writing module 3720 is further configured to: determine, if the value of the sixth flag is a second value, that a current filter bank is not the second target filter bank, determine a value of a fourth flag corresponding to each filter, and write the fourth flag and the value thereof into the bitstream, the fourth flag being configured for indicating whether tap coefficients of a current filter use the shared nonlinear clipping index; and write, if the value of the fourth flag is a first value, a second nonlinear clipping index into the bitstream, the second nonlinear clipping index being the nonlinear clipping index shared by the tap coefficients of the filter.

In an exemplary embodiment, based on the foregoing solution, a preset mapping relationship exists between different nonlinear clipping indexes and different nonlinear clipping intervals. The writing module 3720 is configured to write the target nonlinear clipping index and a target nonlinear clipping interval corresponding thereto into the bitstream, the target nonlinear clipping interval being configured for performing a nonlinear clipping operation on an input of the at least one filter.

The coding apparatus embodiments and the coding method embodiments may correspond to each other. For similar descriptions, refer to the coding method embodiments. To avoid duplication, details are not described herein again. For example, the coding apparatus shown in FIG. 37 may perform the foregoing embodiments of the coding method, and the foregoing and other operations and/or functions of the modules in the apparatus are respectively intended to implement the method embodiments corresponding to nodes in a master node group. For brevity, details are not described herein again.

The apparatuses in some embodiments of the present disclosure is described above with reference to the accompanying drawings from the perspective of functional modules. The functional modules may be implemented in a form of hardware, may be implemented in a form of software, or may be implemented in a combination of hardware and software modules. For example, the operations of the method embodiments in some embodiments of the present disclosure may be completed by using an integrated logic circuit of hardware and/or an instruction in a form of software in a processor. The operations of the method disclosed with reference to some embodiments of the present disclosure may be directly implemented by a hardware decoding processor, or may be implemented by combining hardware and software modules in the decoding processor. In some embodiments, the software module may be located in a mature storage medium in the art, such as a random access memory, a flash memory, a read-only memory, a programmable read-only memory, an electrically-erasable programmable memory, or a register. The storage medium is located in the memory. The processor reads information in the memory and completes the operations in the method embodiments in combination with hardware thereof.

One or more components of FIG. 37 may be integrated into a single component, or conversely, a single component may be implemented as multiple discrete elements. Additionally or alternatively, different subsets of the illustrated components may be combined in various configurations.

FIG. 38 is a schematic block diagram of an electronic device 3800 according to some embodiments of the present disclosure. The electronic device 3800 in FIG. 38 may be configured to perform the foregoing coding/decoding method. The electronic device 3800 may be a coder or a decoder.

As shown in FIG. 38, the electronic device 3800 may include:
a memory 3810 and a processor 3820, the memory 3810 being configured to store a computer program 3830 and transmit program code 33 to the processor 3820. For example, the processor 3820 may invoke the computer program 3830 from the memory 3810 and run the computer program, to implement the method in some embodiments of the present disclosure.

For example, the processor 3820 may be configured to perform the operations in the foregoing method according to instructions in the computer program 3830.

In some embodiments of the present disclosure, the processor 3820 may include, but is not limited to:
a general-purpose processor, a digital signal processor (DSP), an application specific integrated circuit (ASIC), a field programmable gate array (FPGA), or another programmable logic device, discrete gate or transistor logic device, or discrete hardware component.

In some embodiments of the present disclosure, the memory 3810 includes, but is not limited to, a volatile memory and/or a non-volatile memory.

In some embodiments of the present disclosure, the computer program 3830 may be divided into one or more modules. The one or more modules are stored in the memory 3810 and executed by the processor 3820, to complete the coding method or decoding method provided in the present disclosure. The one or more modules may be a series of computer program instruction sections that can implement specific functions. The instruction sections are configured for describing an execution process of the computer program 3830 in the electronic device.

As shown in FIG. 38, the electronic device 3800 may further include:
a transceiver 3840, the transceiver 3840 being connected to the processor 3820 or the memory 3810.

The processor 3820 may control the transceiver 3840 to communicate with another device and may transmit information or data to another device or receive information or data transmitted by another device. The transceiver 3840 may include a transmitter and a receiver. The transceiver 3840 may further include an antenna, and a quantity of the antenna may be one or more.

The components in the electronic device 3830 are connected by using a bus system. In addition to a data bus, the bus system further includes a power bus, a control bus, and a state signal bus.

One or more components of FIG. 38 may be integrated into a single component, or conversely, a single component may be implemented as multiple discrete elements. Additionally or alternatively, different subsets of the illustrated components may be combined in various configurations.

According to some embodiments of the present disclosure, the method for decoding further includes, determining, based on the value of the sixth flag being a second value, that a current filter bank is different from the second target filter bank; parsing the bitstream to determine a third flag corresponding to each filter bank, the third flag indicating whether the current filter bank is a first target filter bank, and tap coefficients of at least one filter comprised in the first target filter bank using the shared nonlinear clipping index; parsing, based on a value of the third flag being a first value, the bitstream to determine a fourth flag corresponding to each filter in the first target filter bank, the fourth flag indicating whether tap coefficients of a current filter use the shared nonlinear clipping index; and obtaining, based on a value of the fourth flag being a first value, a second nonlinear clipping index, the second nonlinear clipping index being the nonlinear clipping index shared by the tap coefficients of the filter.

The method for decoding further includes, determining, based on the value of the sixth flag being a second value, that a current filter bank is different from the second target filter bank; parsing the bitstream to determine a fourth flag corresponding to each filter, the fourth flag indicating whether tap coefficients of a current filter use the shared nonlinear clipping index; and obtaining, based on a value of the fourth flag being a first value, a second nonlinear clipping index, the second nonlinear clipping index being the nonlinear clipping index shared by the tap coefficients of the filter.

The method for decoding further includes, determining, based on the value of the second flag being a second value, that a filter having tap coefficients using the shared nonlinear clipping index is missing in the plurality of filter banks; determining, based on the value of the third flag being a second value, that a filter having tap coefficients using the shared nonlinear clipping index missing in a current filter bank; or determining, based on the value of the fourth flag being a second value, that tap coefficients of a current filter do not use the shared nonlinear clipping index.

According to some embodiments of the present disclosure, a computer storage medium is provided. The computer storage medium has a computer program stored therein. The computer program, when executed by a computer, causes the computer to perform the method in the foregoing method embodiments. Alternatively, some embodiments of the present disclosure further provide a computer program product including instructions. The instructions, when executed by a computer, cause the computer to perform the method in the foregoing method embodiments.

According to some embodiments of the present disclosure, a computer program product or a computer program is provided. The computer program product or the computer program includes computer instructions. The computer instructions are stored in a computer-readable storage medium. A processor of the computer device reads the computer instructions from the computer-readable storage medium. The processor executes the computer instructions, to cause the computer device to perform the method in the foregoing method embodiments. In some embodiments of the present disclosure, the computer program is executed by the processor to perform a coding method to form a bitstream, and the bitstream is stored in the computer-readable storage medium.

A person of ordinary skill in the art may be aware that in combination with the examples described in embodiments disclosed in the present disclosure, modules and algorithm operations can be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of the present disclosure.

The foregoing descriptions are merely specific implementations of the present disclosure, but are not intended to limit the protection scope of the present disclosure. Any variation or replacement readily figured out by a person skilled in the art within the technical scope disclosed in the present disclosure falls within the protection scope of the present disclosure. Therefore, the protection scope of the present disclosure is subject to the protection scope of the claims.

What is claimed is:

1. A method for decoding performed by an electronic device, the method comprising:
parsing a bitstream, to determine a target flag in the bitstream indicating whether tap coefficients of at least one filter use a shared nonlinear clipping index; and
obtaining, based on a value of the target flag being a first value, a target nonlinear clipping index from the bitstream, the target nonlinear clipping index being shared by the tap coefficients of the at least one filter.

2. The method according to claim 1, wherein the target flag comprises a first flag indicating whether tap coefficients of filters in a plurality of filter banks supporting sharing of a nonlinear clipping index use the shared nonlinear clipping index, and
wherein the target nonlinear clipping index comprises a first nonlinear clipping index, the first nonlinear clipping index being shared by the tap coefficients of the filters in the plurality of filter banks.

3. The method according to claim 1, wherein the target flag comprises a second flag indicating whether a first target filter bank exists,
wherein tap coefficients of at least one filter comprised in the first target filter bank uses the shared nonlinear clipping index, and
wherein the method further comprises:
parsing, based on a value of the second flag being a first value, the bitstream to determine a third flag corresponding to each filter bank, the third flag indicating whether a current filter bank is the first target filter bank;
parsing, based on a value of the third flag being a first value, the bitstream to determine a fourth flag corresponding to each filter in the first target filter bank, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

4. The method according to claim 1, wherein the target flag comprises a third flag corresponding to each filter bank, the third flag indicating whether a current filter bank is a first target filter bank,
wherein tap coefficients of at least one filter comprised in the first target filter bank uses the shared nonlinear clipping index, and
wherein the method further comprises:
parsing, based on a value of the third flag being a first value, the bitstream to determine a fourth flag corresponding to each filter in the first target filter bank, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

5. The method according to claim 1, wherein the target flag comprises a fourth flag corresponding to each filter,
wherein the fourth flag indicates whether tap coefficients of a current filter use the shared nonlinear clipping index, and
wherein the target nonlinear clipping index comprises a second nonlinear clipping index, the second nonlinear clipping index being shared by the tap coefficients of the filter.

6. The method according to claim 1, wherein the target flag comprises a fifth flag indicating whether a second target filter bank exists,
wherein tap coefficients of filters in the second target filter bank uses the shared nonlinear clipping index, and
wherein the method further comprises:
parsing, based on a value of the fifth flag being a first value, the bitstream to determine a sixth flag corresponding to each filter bank, the sixth flag indicating whether a current filter bank is the second target filter bank; and
obtaining, based on a value of the sixth flag is a first value, a third nonlinear clipping index, the third nonlinear clipping index being shared by the tap coefficients of the filters in the second target filter bank.

7. The method according to claim 1, wherein the target flag comprises a sixth flag corresponding to each filter bank, the sixth flag indicating whether a current filter bank is a second target filter bank,
wherein tap coefficients of filters in the second target filter bank uses the shared nonlinear clipping index, and
wherein the target nonlinear clipping index comprises a third nonlinear clipping index, the third nonlinear clipping index being shared by the tap coefficients of the filters in the second target filter bank.

8. The method according to claim 2, further comprising:
parsing, based on a value of the first flag is a second value, the bitstream to determine a second flag indicating whether at least one first target filter bank exists, tap coefficients of at least one filter comprised in a first target filter bank using the shared nonlinear clipping index;
parsing, based on a value of the second flag being a first value, the bitstream to determine a third flag corresponding to each filter bank, the third flag indicating whether a current filter bank is the first target filter bank;
parsing, based on a value of the third flag is a first value, the bitstream to determine a fourth flag corresponding to each filter in the first target filter bank, the fourth flag indicating whether tap coefficients of a current filter use the shared nonlinear clipping index; and
obtaining, based on a value of the fourth flag is a first value, a second nonlinear clipping index, the second nonlinear clipping index being shared by the tap coefficients of the filter.

9. The method according to claim 2, further comprising:
parsing, based on a value of the first flag being a second value, the bitstream to determine a third flag corresponding to each filter bank, the third flag whether a current filter bank is a first target filter bank, tap coefficients of at least one filter comprised in the first target filter bank using the shared nonlinear clipping index;
parsing, based on a value of the third flag is a first value, the bitstream to determine a fourth flag corresponding to each filter in the first target filter bank, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

10. The method according to claim 2, further comprising:
parsing, based on a value of the first flag being a second value, the bitstream to determine a fourth flag corresponding to each filter, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

11. The method according to claim 2, further comprising:
parsing, based on a value of the first flag being a second value, the bitstream to determine a fifth flag indicating whether at least one second target filter bank exists, tap coefficients of filters in a second target filter bank using the shared nonlinear clipping index;
parsing, based on a value of the fifth flag being a first value, the bitstream to determine a sixth flag corresponding to each filter bank, the sixth flag indicating whether a current filter bank is the second target filter bank; and
obtaining, based on a value of the sixth flag being a first value, a third nonlinear clipping index, the third nonlinear clipping index being shared by the tap coefficients of the filters in the second target filter bank.

12. The method according to claim 11, further comprising:
determining, based on the value of the fifth flag being a second value, that the second target filter bank is missing in the plurality of filter banks;
parsing the bitstream to determine a second flag, the second flag indicating whether at least one first target filter bank exists, tap coefficients of at least one filter comprised in a first target filter bank using the shared nonlinear clipping index;
parsing, based on a value of the second flag being a first value, the bitstream to determine a third flag corresponding to each filter bank, the third flag indicating whether a current filter bank is the first target filter bank;
parsing, based on a value of the third flag being a first value, the bitstream to determine a fourth flag corresponding to each filter in the first target filter bank, the fourth flag indicating whether tap coefficients of a current filter use the shared nonlinear clipping index; and
obtaining, based on a value of the fourth flag is a first value, a second nonlinear clipping index, the second nonlinear clipping index being shared by the tap coefficients of the filter.

13. The method according to claim 11, further comprising:
determining, based on the value of the fifth flag being a second value, that the second target filter bank is missing in the plurality of filter banks;
parsing the bitstream to determine a third flag corresponding to each filter bank, the third flag indicating whether a current filter bank is a first target filter bank, tap coefficients of at least one filter comprised in the first target filter bank using the shared nonlinear clipping index;
parsing, based on a value of the third flag being a first value, the bitstream to determine a fourth flag corresponding to each filter in the first target filter bank, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

14. The method according to claim 11, further comprising:
determining, based on the value of the fifth flag being a second value, that the second target filter bank is missing in the plurality of filter banks;
parsing the bitstream to determine a fourth flag corresponding to each filter, the fourth flag indicating whether tap coefficients of a current filter use the shared nonlinear clipping index; and
obtaining, based on a value of the fourth flag is a first value, a second nonlinear clipping index, the second nonlinear clipping index being shared by the tap coefficients of the filter.

15. The method according to claim 11, further comprising:
determining, based on the value of the sixth flag being a second value, that a current filter bank is different from the second target filter bank;
parsing the bitstream to determine a third flag corresponding to each filter bank, the third flag indicating whether the current filter bank is a first target filter bank, tap coefficients of at least one filter comprised in the first target filter bank using the shared nonlinear clipping index;
parsing, based on a value of the third flag being a first value, the bitstream to determine a fourth flag corresponding to each filter in the first target filter bank, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

16. The method according to claim 11, further comprising:
determining, based on the value of the sixth flag being a second value, that a current filter bank is different from the second target filter bank;
parsing the bitstream to determine a fourth flag corresponding to each filter, the fourth flag indicating whether tap coefficients of a current filter use the shared nonlinear clipping index; and
obtaining, based on a value of the fourth flag being a first value, a second nonlinear clipping index, the second nonlinear clipping index being shared by the tap coefficients of the filter.

17. The method according to claim 2, further comprising:
parsing, based on a value of the first flag being a second value, the bitstream to determine a sixth flag corresponding to each filter bank, the sixth flag indicating whether a current filter bank is a second target filter bank, tap coefficients of filters in the second target filter bank using the shared nonlinear clipping index; and
obtaining, based on a value of the sixth flag being a first value, a third nonlinear clipping index, the third nonlinear clipping index being shared by the tap coefficients of the filters in the second target filter bank.

18. The method according to claim 1, wherein a preset mapping relationship is established between different nonlinear clipping indexes and different nonlinear clipping intervals; and
based on the obtaining of the target nonlinear clipping index, the method further comprises:
obtaining a target nonlinear clipping interval having a mapping relationship with the target nonlinear clipping index, to perform a nonlinear clipping operation on an input of the at least one filter by using the target nonlinear clipping interval.

19. An electronic device for decoding, comprising,
at least one memory configured to store computer program code; and
at least one processor configured to read the program code and operate as instructed by the program code, wherein the program code is configured to cause the at least one processor to:
parse a bitstream, to determine a target flag in the bitstream indicating whether tap coefficients of at least one filter use a shared nonlinear clipping index; and
obtain, based on a value of the target flag being a first value, a target nonlinear clipping index from the bitstream, the target nonlinear clipping index being shared by the tap coefficients of the at least one filter.

20. A non-transitory computer-readable storage medium, storing computer program code, when executed by at least one processor, causes the at least one processor to at least:
parse a bitstream, to determine a target flag in the bitstream indicating whether tap coefficients of at least one filter use a shared nonlinear clipping index; and
obtain, based on a value of the target flag being a first value, a target nonlinear clipping index from the bitstream, the target nonlinear clipping index being shared by the tap coefficients of the at least one filter.
